(19) United States
(12) Patent Application Publication
(10) Pub. No.: US 2015/0341853 A1
(43) Pub. Date: Nov. 26, 2015

(54) METHOD AND APPARATUS FOR CONTROLLING BEACON TRANSMISSION IN WIRELESS COMMUNICATION SYSTEM

(71) Applicant: LG ELECTRONICS INC., Seoul (KR)

(72) Inventors: Heejeong CHO, Seoul (KR); Eunjong LEE, Seoul (KR); Hyeyoung CHOI, Seoul (KR); Genebeck HAHN, Seoul (KR)

(73) Assignee: LG ELECTRONICS INC., Seoul (KR)

(21) Appl. No.: 14/654,800

(22) PCT Filed: Jan. 8, 2014
(86) PCT No.: PCT/KR2014/000181

§ 371 Date: Jun. 22, 2015

Related U.S. Application Data
(60) Provisional application No. 61/750,364, filed on Jan. 9, 2013.
(60) Provisional application No. 61/754,644, filed on Jan. 21, 2013.

(51) Int. Cl. H04W 48/18; H04W 40/24; H04W 48/20; H04L 12/26

(52) U.S. Cl. CPC H04W 48/18; H04L 43/12; H04W 40/244; H04W 48/20; H04W 88/08

(57) ABSTRACT

A method and apparatus for controlling beacon transmission in a wireless communication system. A cellular node may control beacon transmission of an access point (AP) in an infrastructure basic service set (BSS). The cellular node may adjust an beacon interval of a plurality of APs and a start point of the beacon interval of the plurality of APs so that beacon transmissions of the plurality of APs do not overlap each other. Or, a cellular node may control beacon transmission of a general device in an independent BSS.

### BACKGROUND OF THE INVENTION

1. Field of the Invention

The present invention relates to wireless communications, and more specifically, to a method and apparatus for controlling beacon transmission in a wireless communication system.

2. Related Art

With the recent trend of increasing high-rate data traffic, fifth generation mobile communication technologies are in discussion for their realistic and efficient backup. One of requirements for fifth generation mobile communication technologies is the interworking between heterogeneous wireless communication systems, particularly between a cellular system and a wireless LAN (WLAN) system. The cellular system may be one of a 3^{rd} generation partnership project (3GPP) long-term evolution (LTE) system, a 3GPP LTE-A (advanced) system, and an institute of electrical and electronics engineers (IEEE) 802.16 (WiMax, WiBro) system. The WLAN system may be an IEEE 802.11 (Wi-Fi) system. In particular, WLAN is a wireless communication system that is commonly used for various user equipments, and thus, the cellular-WLAN interoperation is a high-priority convergence technique. Offloading by the cellular-WLAN interoperation may increase the coverage and capacity of the cellular system.

The arrival of the ubiquitous environment led to a sharp increase in demand for seamless services anytime, anywhere. The fifth generation mobile communication system may adopt a plurality of radio access technologies (RATs) for always gaining easy access and maintaining efficient performance in any place. In other words, the fifth-generation mobile communication system may use multiple RATs in a converging manner through the interoperation between heterogeneous wireless communication systems. Each entity in the plurality of RATs constituting a fifth-generation mobile communication system may exchange information therebetween, and accordingly, the optimal communication system may be provided to a user in the fifth-generation mobile communication system. Among the plurality of RATs constituting the fifth-generation mobile communication system, a specific RAT may operate as a primary RAT system, and another specific RAT may operate as a secondary RAT system. That is, the primary RAT system may mainly play a role to provide a communication system to a user in the fifth-generation mobile communication system, while the secondary RAT system may assist the primary RAT system. In general, a 3GPP LTE(-A) or IEEE 802.16 cellular system with relatively broad coverage may be a primary RAT system, and a Wi-Fi system with relatively narrower coverage may be a secondary RAT system.

In a fifth-generation mobile communication system constituted of a plurality of RATs, a primary RAT system needs to grasp the entities of a secondary RAT system that operates within its own coverage. For example, if a primary RAT system is a cellular system, and a secondary RAT system is a Wi-Fi system, a cellular node such as an eNodeB (eNB), mobility management entity (MME), or new cellular entity need be aware of which access points (APs) are in operation within its coverage. Or, a primary RAT system needs to grasp whether a general device which operates within its own coverage can operate in a secondary RAT system. For example, a cellular node such as an eNB, MME, or new cellular entity need be aware whether a general device such as a user equipment (UE) or mobile station (MS) can operate in a Wi-Fi system.

A method for configuring, by a primary RAT system, an optimal communication system by acquiring and controlling information related to beacon transmission and informing the information to general device is required.

### SUMMARY OF THE INVENTION

The present invention provides a method and apparatus for controlling beacon transmission in a wireless communication system. The present invention provides a method for controlling beacon transmissions of APs in an infrastructure basic service set (BSS). The present invention provides a method for controlling beacon transmissions of devices in an independent BSS.

In an aspect, a method for controlling, by a node of a primary radio access technology (RAT) system, beacon transmission in a wireless communication system is provided. The method includes adjusting an beacon interval of a plurality of access points (APs) of a secondary RAT system and a start point of the beacon interval of the plurality of APs so that beacon transmissions of the plurality of APs do not overlap each other. The plurality of APs is included in an infrastructure basic service set (BSS).

The beacon interval of the plurality of APs may be adjusted to a lower value than an original beacon interval.

The beacon interval of the plurality of APs may be adjusted to a higher value than an original beacon interval.

The method may further include transmitting a request which commands an AP, among the plurality of APs, to transmit an unsolicited probe response frame, and receiving a response, which includes a time point at which the unsolicited probe response frame is transmitted, to the request from the AP.

The method may further include transmitting the time point to at least one devices within coverage of the AP.

The request and the response may be transmitted through a cellular network or an

Internet protocol (IP) network.

The primary RAT system may be a cellular system, and the node may be one of a eNodeB (eNB), a mobility management entity (MME), or a new entity of the cellular system.

The secondary RAT system may be a Wi-Fi system.

In another aspect, a method for transmitting, by an access point (AP) of a secondary radio access technology (RAT) system, a probe response frame in a wireless communication system is provided. The method includes receiving an adjusted beacon interval and an adjusted start point of the beacon interval so that beacon transmissions of a plurality of APs, included in an infrastructure basic service set (BSS), do not overlap each other from a node of a primary RAT system, receiving a request which commands the AP to transmit an unsolicited probe response frame from the node of the primary RAT system, transmitting a response, which includes a time point at which the unsolicited probe response frame is transmitted, to the request to the node of the primary RAT system, and transmitting the unsolicited probe response frame.

The adjusted beacon interval may have a higher value than an original beacon interval.

The unsolicited probe response frame may be transmitted in an event-triggered manner.

In another aspect, a method for controlling, by a node of a primary radio access technology (RAT) system, an operation of a device in a wireless communication system is provided. The method includes transmitting a request message to a device of a secondary RAT system, wherein the request message includes an action which the device is to perform, and a frequency band in which the device operates.

The request message may be transmitted when client cooperation or direct communication between devices is required.

The request message may be transmitted the node of the primary RAT system measures interference of each frequency band.

The action may include at least one of Wi-Fi radio frequency (RF) ON, Wi-Fi RF OFF, beacon transmission and beacon suspension.

Beacon transmission of an AP or device can be controlled efficiently.

### BRIEF DESCRIPTION OF THE DRAWINGS

FIG. 1 shows a cellular system.

FIG. 2 shows a structure of a radio frame in 3GPP LTE.

FIG. 3 shows a wireless local area network (WLAN) system.

FIG. 4 shows an example of a frame structure of IEEE 802.11.

FIG. 5 shows an example of a scenario of a converged communication system of a cellular system and a Wi-Fi system.

FIG. 6 shows a beacon transmission on a busy network.

FIG. 7 shows a case in which an AP transmits an unsolicited probe response frame to decrease acquisition delay when a beacon interval of each AP is adjusted to a higher value according to an embodiment of the present invention.

FIG. 8 shows a case in which an AP transmits an unsolicited probe response frame to decrease change delay when a beacon interval of each AP is adjusted to a higher value according

FIG. 9 shows an example of a method for obtaining a start point of a beacon interval according to an embodiment of the present invention.

FIG. 10 shows an example of a method for obtaining a start point of a beacon interval according to another embodiment of the present invention.

FIG. 11 shows an example of a method for obtaining information related to beacon transmission according to an embodiment of the present invention.

FIG. 12 shows an example of a method for controlling beacon transmission according to an embodiment of the present invention.

FIG. 13 shows an example of a method for obtaining a start point of a beacon interval according to another embodiment of the present invention.

FIG. 14 shows an example of a method for obtaining information related to beacon transmission according to another embodiment of the present invention.

FIG. 15 shows an example of a method for controlling beacon transmission according to another embodiment of the present invention.

FIG. 16 shows an example of a method for obtaining information related to beacon transmission according to another embodiment of the present invention.

FIG. 17 shows an example of a method for controlling beacon transmission according to another embodiment of the present invention.

FIG. 18 shows an example of a method for transmitting information related to beacon transmission according to an embodiment of the present invention.

FIG. 19 shows scanning durations when a general device performs scanning according to a conventional method.

FIG. 20 shows scanning durations when a general device performs scanning according to an embodiment of the present invention.

FIG. 21 shows a beacon transmission in an independent BSS.

FIG. 22 shows an example of a method for controlling Wi-Fi activation of a special-purpose device according to an embodiment of the present invention.

FIG. 23 shows an example of a method for controlling, by a cellular node, beacon transmission of a special-purpose device according to an embodiment of the present invention.

FIG. 24 shows an example of a method for controlling, by a cellular node, beacon transmission of a special-purpose device according to another embodiment of the present invention.

FIG. 25 shows a case in which a special-purpose device transmits an unsolicited probe response frame to decrease acquisition delay when a beacon interval of the special-purpose device is adjusted to a higher value according to an embodiment of the present invention.

FIG. 26 shows an example of a method for controlling, by a cellular node, beacon transmission of a special-purpose device according to another embodiment of the present invention.

FIG. 27 is a block diagram showing wireless communication system to implement an embodiment of the present invention.

### DESCRIPTION OF EXEMPLARY EMBODIMENTS

A technology below can be used in a variety of wireless communication systems, such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented using radio technology, such as universal terrestrial radio access (UTRA) or CDMA2000. TDMA can be implemented using radio technology, such as global system for mobile communications (GSM)/general packet radio service (GPRS)/enhanced data rates for GSM evolution (EDGE). OFDMA can be implemented using radio technology, such as IEEE 802.11(Wi-Fi), IEEE 802.16(WiMAX), IEEE 802-20, or Evolved UTRA (E-UTRA). IEEE 802.16m is the evolution of IEEE 802.16e, and it provides a backward compatibility with an IEEE 802.16e-based system. UTRA is part of a universal mobile telecommunications system (UMTS). 3rd generation partnership project (3GPP) long term evolution (LTE) is part of evolved UMTS (E-UMTS) using evolved-UMTS terrestrial radio access (E-UTRA), and it adopts OFDMA in downlink (DL) and SC-FDMA in uplink (UL). LTE-A (advanced) is the evolution of 3GPP LTE.

3GPP LTE(-A) and IEEE 802.11 are chiefly described as an example in order to clarify the description, but the technical spirit of the present invention is not limited to 3GPP LTE(-A) and IEEE 802.11.

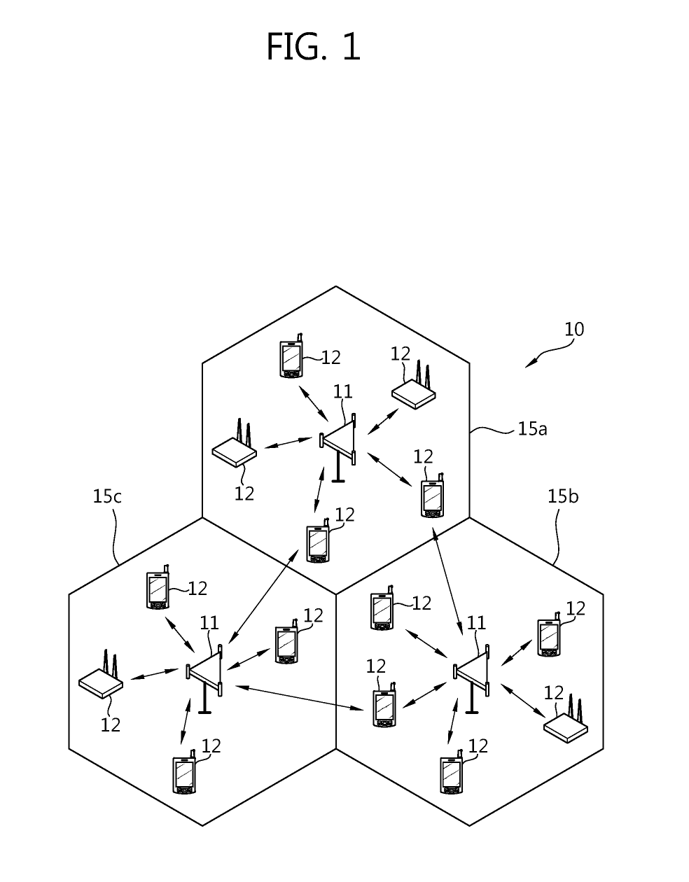

FIG. 1 shows a cellular system.

Referring to FIG. 1, the cellular system 10 includes one or more base stations (BSs) 11. The BSs 11 provide communication services to respective geographical areas (in general called ‘cells’) 15a, 15b, and 15c. Each of the cells can be divided into a number of areas (called ‘sectors’). A user equipment (UE) 12 can be fixed or mobile and may be referred to as another terminology, such as a mobile station (MS), a mobile terminal (MT), a user terminal (UT), a subscriber station (SS), a wireless device, a personal digital assistant (PDA), a wireless modem, or a handheld device. In general, the BS 11 refers to a fixed station that communicates with the UEs 12, and it may be referred to as another terminology, such as an evolved-NodeB (eNB), a base transceiver system (BTS), or an access point.

The UE generally belongs to one cell. A cell to which a UE belongs is called a serving cell. A BS providing the serving cell with communication services is called a serving BS. A wireless communication system is a cellular system, and so it includes other cells neighboring a serving cell. Other cells neighboring the serving cell are called neighbor cells. A BS providing the neighbor cells with communication services is called as a neighbor BS. The serving cell and the neighbor cells are relatively determined on the basis of a UE.

This technology can be used in the downlink (DL) or the uplink (UL). In general, DL refers to communication from the BS 11 to the UE 12, and UL refers to communication from the UE 12 to the BS 11. In the DL, a transmitter may be part of the BS 11 and a receiver may be part of the UE 12. In the UL, a transmitter may be part of the UE 12 and a receiver may be part of the BS 11.

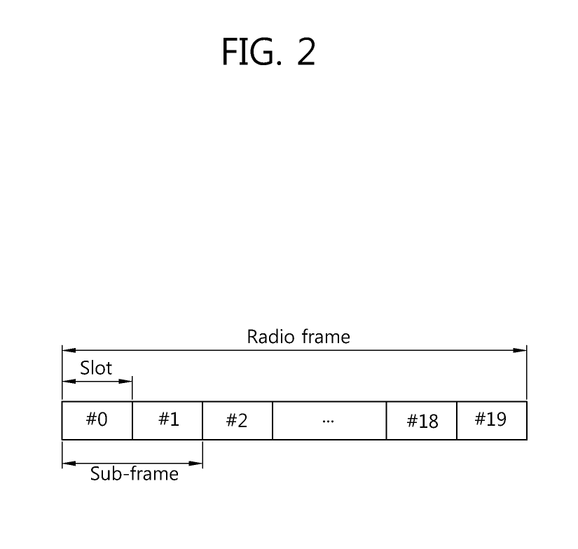

FIG. 2 shows a structure of a radio frame in 3GPP LTE. It may be referred to Section 4 of 3GPP TS 36.211 V8.2.0 (2008-03).

Referring to FIG. 2, the radio frame includes 10 subframes, and one subframe includes two slots. The slots in the radio frame are numbered by #0 to #19. A transmission time interval (TTI) is a scheduling unit for a data transmission. In 3GPP LTE, one TTI may be identical with a time taken for transmitting one subframe. A radio frame may have a length of 10 ms, a subframe may have a length of 1 ms, and a slot may have a length of 0.5 ms.

One slot includes a plurality of orthogonal frequency division multiplexing (OFDM) symbols in a time domain and a plurality of subcarriers in a frequency domain. Since 3GPP LTE uses OFDMA in downlink, the OFDM symbols are used to express a symbol period. The OFDM symbols may be called by other names depending on a multiple-access scheme. For example, when a single carrier frequency division multiple access (SC-FDMA) is in use as an uplink multi-access scheme, the OFDM symbols may be called SC-FDMA symbols. A resource block (RB), a resource allocation unit, includes a plurality of continuous subcarriers in a slot. The structure of the radio frame is merely an example. Namely, the number of subframes included in a radio frame, the number of slots included in a subframe, or the number of OFDM symbols included in a slot may vary.

3GPP LTE defines that one slot includes seven OFDM symbols in a normal cyclic prefix (CP) and one slot includes six OFDM symbols in an extended CP.

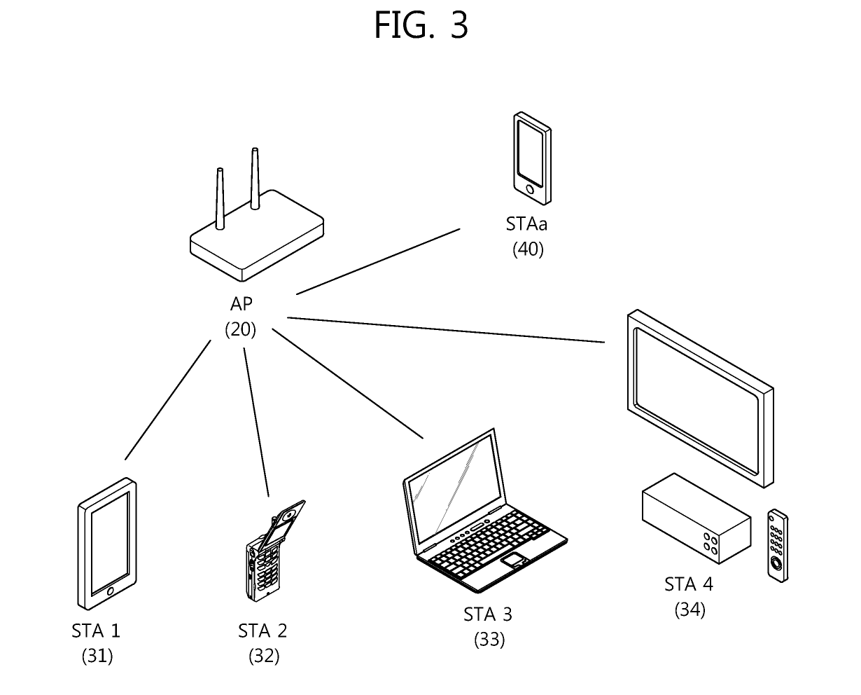

FIG. 3 shows a wireless local area network (WLAN) system.

The WLAN system may also be referred to as a Wi-Fi system. Referring to FIG. 3, the WLAN system includes one access point (AP) 20 and a plurality of stations (STAs) 31, 32, 33, 34, and 4). The AP 20 may be linked to each STA 31, 32, 33, 34, and 40 and may communicate therewith. The WLAN system includes one or more basic service sets (BSSs). The BSS is a set of STAs that may be successfully synchronized with each other and may communicate with each other, and does not mean a specific region.

An infrastructure BSS includes one or more non-AP stations, APs that provide a distribution service (DS), and a DS that links a plurality of APs with each other. In the infrastructure BSS, an AP manages non-AP STAs of the BSS. Accordingly, the WLAN system shown in FIG. 3 may include an infrastructure BSS. In contrast, an independent BSS (IBSS) is a BSS that operates in ad-hoc mode. The IBSS does not include an AP and thus lacks a centralized management entity. That is, in the IBSS, the non-AP STAs are managed in a distributed manner. The IBSS may have all the STAs constituted of mobile STAs and is not allowed to access the distribution system, thus achieving a self-contained network.

The STA is random functional medium that includes a physical layer interface for a wireless medium and an media access control (MAC)) observing IEEE 802.11 standards, and in its broader concepts, it includes both the AP and non-AP station.

The non-AP STA is an STA, not an AP. The non-AP STA may also be referred to as a mobile terminal, a wireless device, a wireless transmit/receive unit (WTRU), a user equipment (UE), a mobile station (MS), a mobile subscriber unit or simply as a user. Hereinafter, for ease of description, the non-AP STA denotes an STA.

The AP is a functional entity that provides access to a distribution system via a wireless medium for an STA associated with the AP. In the infrastructure BSS including an AP, communication between STAs is basically done via an AP, but in case a direct link is established, direct communication may be achieved between STAs. The AP may also be referred to as a central controller, a base station (BS), a NodeB, a base transceiver system (BTS), or a site controller.

A plurality of infrastructure BSSs may be linked with each another through a distribution system. The plurality of BSSs linked with each another is referred to as an extended service set (ESS). The APs and/or STAs included in the ESS may communicate with each other, and in the same ESS, an STA may move from one BSS to another, while in seamless communication.

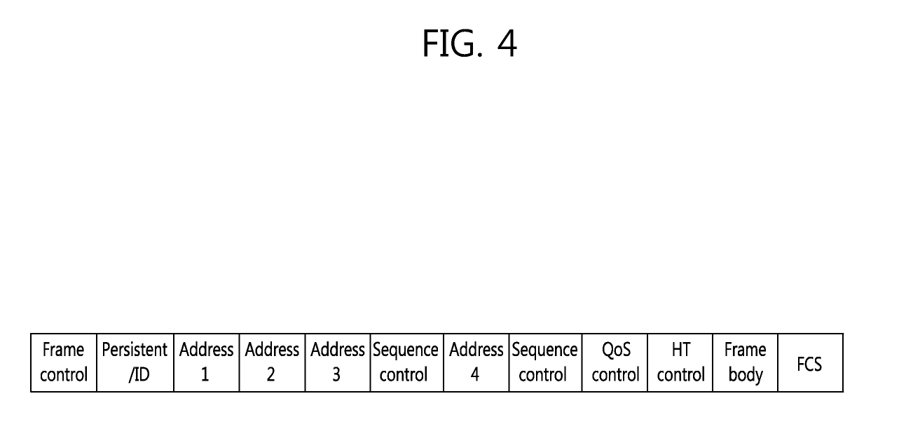

FIG. 4 shows an example of a frame structure of IEEE 802.11.

A frame of IEEE 802.11 includes a set of fields in a fixed order. Referring to FIG. 4, the frame of IEEE 802.11 includes a frame control field, a duration/ID field, an address 1 field, an address 2 field, an address 3 field, a sequence control field, an address 4 field, a quality of service (QoS) control field, an HT control field, a frame body field, and a frame check sequence (FCS) field. Among the fields listed above, the frame control field, the duration/ID field, the address 1 field, and the FCS field constitute a minimum IEEE 802.11 frame format, and may be included in all IEEE 802.11 frames. The address 2 field, the address 3 field, the sequence control field, the address 4 field, the QoS control field, the HT control field, and the frame body field may be included only in a specific frame type.

The frame control field may include various subfields. The duration/ID field may be 16 bits in length. The address field may include a basic service set identifier (BSSID), a source address (SA), a destination address (DA), a transmitting STA address (TA), and a receiving STA address (RA). In the address field, different fields may be used for other purposes according to a frame type. The sequence control field can be used when fragments are reassembled or when an overlapping frame is discarded. The sequence control field may be 16 bits, and may include two subfields indicating a sequence number and a fragment number. The FCS field can be used to check an error of a frame received by a station. The FCS field may be a 32-bit field including a 32-bit cyclic redundancy check (CRC). An FCS can be calculated across the frame body field and all fields of a media access control (MAC) header.

The frame body field may include information specified for an individual frame type and subtype. That is, the frame body field carries high-level data from one station to another station. The frame body field can also be called a data field. The frame body field can be variously changed in length. A minimum length of the frame body field may be zero octet. A maximum length of the frame body field may be determined by a total sum of a maximum length of a MAC service data unit (MSDU), a length of a mesh control field, and an overhead for encryption or a total sum of a maximum length of an aggregated MSDU (A-MSDU) and an overhead for encryption. The data frame includes high-level protocol data of the frame body field. The data frame may always include the frame control field, the duration/ID field, the address 1 field, the address 2 field, the address 3 field, the sequence control field, the frame body field, and the FCS field. A presence of an address 4 field may be determined by a configuration of a ‘To DS’ subfield and a ‘From DS’ subfield in the frame control field. Another data frame type can be categorized according to a function.

A management frame may always include the frame control field, the duration/ID field, the address 1 field, the address 2 field, the address 3 field, the sequence control field, the frame body field, and the FCS field. Data included in the frame body field generally uses a fixed-length field called a fixed field and a variable-length field called an information element. The information element is a variable-length data unit.

The management frame can be used for various purposes according to a subtype. That is, a frame body field of a different subtype includes different information. A beacon frame reports an existence of a network, and takes an important role of network maintenance. The beacon frame corresponds to a parameter which allows a mobile station to participate in the network. In addition, the beacon frame is periodically transmitted so that the mobile station can scan and recognize the network. A probe request frame is used to scan an IEEE 802.11 network in which the mobile station exists. A probe response frame is a response for the probe request frame. An authentication request is used so that the mobile station requests an access point to perform authentication. An authentication response frame is a response for the authentication request frame. A de-authentication frame is used to finish an authentication relation. An association request frame is transmitted so that the mobile station participates in the network when the mobile station recognizes the compatible network and is authenticated. An association response frame is a response for the association request frame. A de-association frame is used to finish an association relation.

Three states may exist according to an authentication and association procedure in IEEE 802.11. Table 1 below shows the three states of IEEE 802.11.

TABLE 1

| | Authentication | Association |
|---|---|---|
| State 1 | X | X |
| State 2 | ◯ | X |
| State 3 | ◯ | ◯ |

To transmit a data frame, a device must perform the authentication and association procedure with respect to a network. In Table 1, a procedure of transitioning from the state 1 to the state 2 can be called the authentication procedure. The authentication procedure can be performed in such a manner that one device acquires information on a different device and authenticates the different device. The information on the different device can be acquired by using two methods, i.e., a passive scanning method for acquiring information on a different node by receiving a beacon frame and an active scanning method for acquiring the information on the different device by transmitting a probe request message and receiving a probe response message received in response thereto. The authentication procedure can be complete by exchanging an authentication request frame and an authentication response frame.

In Table 1, a procedure of transitioning from the state 2 to the state 3 can be called the association procedure. The association procedure can be complete when two devices exchange the association request frame and the association response frame upon completion of the authentication procedure. An association ID can be allocated by the association procedure.

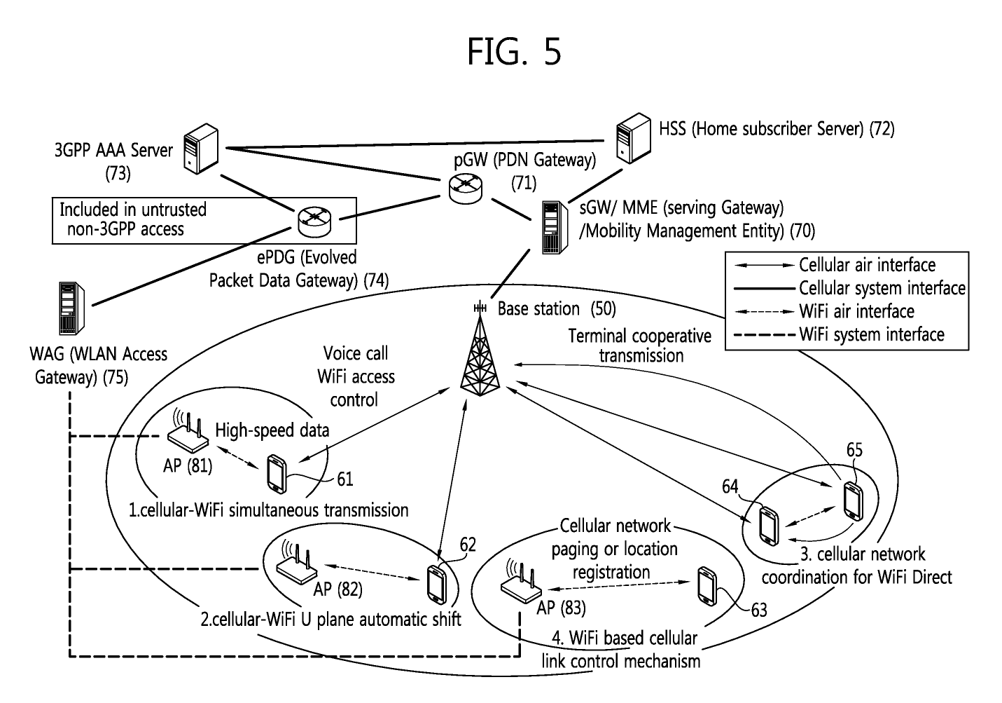

FIG. 5 shows an example of a scenario of a converged communication system of a cellular system and a Wi-Fi system.

It is assumed in FIG. 5 that the cellular system operates as a primary RAT system of the converged communication system, and the Wi-Fi system operates as a secondary RAT system of the converged communication system. Further, the cellular system may be a 3GPP LTE(-A) system. Hereinafter, for ease of description, it is assumed that the primary RAT system of the converged communication system is a 3GPP LTE(-A) system, and the secondary RAT system of the communication system is an IEEE 802.11 system, i.e., a Wi-Fi system. However, embodiments of the present invention are not limited thereto.

Referring to FIG. 5, there are a plurality of general devices 61, 62, 63, 64, and 65 in the coverage of the cellular base station 50. Each of the general devices 61, 62, 63, 64, and 65 may be a user equipment in a cellular system. The cellular base station 50 may communicate with each of the general devices 61, 62, 63, 64, and 65 via a cellular radio interface. For example, the cellular base station 50 may perform voice call communication with each of the general devices 61, 62, 63, 64, and 65 or may control access of each general device 61, 62, 63, 64, and 65 to a Wi-Fi system.

The cellular base station 50 is connected to a serving gateway (S-GW)/mobility management entity (MME) 70 through a cellular system interface. The MME contains a user equipment's access information or information on a user equipment's capability, and such information may be mainly used for mobility management. The MME is in charge of a control plane. The S-GW is a gateway having an E-UTRAN as an end point. The S-GW is in charge of a user plane. The S-GW/MME 70 is connected to a packet data network (PDN) gateway (P-GW) 71 and a home subscriber server (HSS) 72 through the cellular system interface. The PDN-GW is a gateway having a PDN as an end point.

The P-GW 71 and the HSS 72 are connected to a 3GPP access authentication authorization (AAA) server 73 through the cellular system interface. The P-GW 71 and the 3GPP AAA server 73 may be connected to an evolved packet data gateway (e-PDG) 74 through the cellular system interface. The e-PDG 74 may be included only in untrusted non-3GPP access. The e-PDG 74 may be connected to a WLAN access gateway (WAG) 75. The WAG 75 may be in charge of a P-GW in a Wi-Fi system.

Meanwhile, a plurality of APs 81, 82, and 83 may be present in the coverage of the cellular base station 50. Each of the APs 81, 82, and 83 may have coverage which is shorter than that of the cellular base station 50. Each of the APs 81, 82, and 83 may communicate with general devices 61, 62, and 63 that are present in its coverage through a Wi-Fi radio interface. In other words, the general devices 61, 62, and 63 may communicate with the cellular base station 50 and/or APs 81, 82, and 83. Communication methods of the general devices 61, 62, and 63 are as follows:

1) Cellular/Wi-Fi simultaneous radio transmission: the general device 61 may perform high-speed data communication with the AP 81 through a Wi-Fi radio interface while communicating with the cellular base station 50 through a cellular radio interface.
2) Cellular/Wi-Fi user plane automatic shift: the general device 62 may communicate with one of the cellular base station 50 and the AP 82 by user plane automatic shift. At this time, the control plane may be present in both the cellular system and the Wi-Fi system or only in the cellular system.
3) Terminal cooperative transmission: the general device 64 operating as a source device may directly communicate with the cellular base station 50 through a cellular radio interface or may indirectly communicate with the cellular base station 50 through a general device 65 operating as a cooperative device. That is, the cooperative device 65 may assist the source device 64 so that the source device 64 may indirectly communicate with the cellular base station 50 through itself. The source device 64 and the cooperative device 65 communicate with each other through a Wi-Fi radio interface.
4) Wi-Fi-based cellular link control mechanism: the AP 83 may perform a cellular link control mechanism such as paging or location registration of a network for the cellular general device 63. The general device 63 is not directly connected to the cellular base station 50 and may directly communicate with the cellular base station 50 thorough the AP 83.

Each of the APs 81, 82, and 83 is connected to the WAG 75 through a Wi-Fi system interface.

Currently, a cellular system and WLAN system are independently operated and the independent operation of each system is one of factors that hinder efficiency of off-loading between the systems. When the cellular system and WLAN system constitute a converged communication system described in FIG. 5, the cellular system needs to manage information related to transmission of frames such as a beacon frame, a probe frame, etc., in order to enhance an unnecessary access time and power consumption for the WLAN system of a general device. Further, since a beacon transmission method depends on a BSS architecture of the WLAN system, a beacon control method depending on the BSS architecture of the WLAN system needs to be defined.

First, a method in which a primary RAT system actively controls beacon transmission of an entity of a secondary RAT system included in an infrastructure BSS is described. That is, a method in which the primary RAT system collects and/or controls information related to beacon transmission of the entity of the secondary RAT system, and notifies the collected and/or controlled information to a general device such as a UE, etc., to optimize the access of the general device to the secondary RAT system is described. The primary RAT system needs to determine which entity of the secondary RAT system operates in coverage thereof. As a result, the entity of the secondary RAT system may notify beacon transmission related information thereof to an AP information management entity such as an AP information management server or a cellular node (e.g., eNB or MME). The beacon transmission related information may include information on a frequency channel such as an operating class, a channel number, etc., and a beacon interval. The frequency channel represents a frequency band in which a beacon is transmitted. The beacon interval represents an interval at which the beacon is transmitted by an AP. In this case, an AP information management entity may control and/or adjust a system configuration such as a beacon interval, a beacon start point, etc., of the entity of the secondary RAT system in coverage thereof through an IP network or a cellular network. The AP information management entity notifies the obtained beacon transmission related information of the entity of the secondary RAT system to the general device such as the UE, etc., to optimize an access procedure to the secondary RAT system of the general device.

Hereinafter, for convenience of the description, it is assumed that the primary RAT system is a 3GPP LTE (or 3GPP LTE-A) which is a cellular system, and the secondary RAT system an IEEE 802.11 (Wi-Fi) which is a WLAN system. However, the embodiment of the present invention is not limited thereto. When the primary RAT system is a 3GPP LTE(-A), the AP information management entity of a primary RAT system may be one of an eNB, MME or new entity. When the secondary RAT system is an IEEE 802.11, an entity of the secondary RAT system may be an AP.

An AP information management server may be a device to provide a generic advertisement service (GAS) using an access network query protocol (ANQP). The ANQP is a query protocol for access network information retrieval transported by GAS public action frames. GAS provides functionality that enables STAs to discover the availability of information related to desired network services, e.g., information about services such as provided in an IBSS, local access services, available subscription service providers (SSPs) and/or subscription service provider networks (SSPNs) or other external networks. GAS uses a generic container to advertise network services' information over an IEEE 802.11 network. Public action frames are used to transport this information. Further, the AP information management server may be a WAG. A new entity may be added between the AP and the management server so that a corresponding entity may combine information on the cellular system transmitted from the AP, change a transmission format, and transmit the combined information to the management server. The added new entity may be a dual-stack gateway or an AP controller, etc. Or, in the description above, the AP information management server may be a device providing an access network discovery and selection function (ANDSF).

A beacon in an IEEE 802.11 is described. A beacon request/report pair enables a STA to request from another STA a list of APs whose beacons it can receive on a specified channel or channels. This measurement may be done by active mode (like active scan), passive mode (like passive scan), or beacon table modes. If the measurement request is accepted and is in passive mode, a duration timer is set. Then the measuring STA monitors the requested channel, measures beacon, probe response, and measurement pilot power levels (received channel power indicator (RCPI)), and logs all beacons, probe responses, and measurement pilots received within the measurement duration. If the measurement request is in active mode, the measuring STA sends a probe request on the requested channel at the beginning of the measurement duration, then monitors the requested channel, measures beacon, probe response, and measurement pilot power levels (RCPI), and logs all beacons, probe responses, and measurement pilots received within the measurement duration. If the request is beacon table mode, then the measuring STA returns a beacon report containing the current contents of any stored beacon information for any supported channel with the requested SSID and BSSID without performing additional measurements.

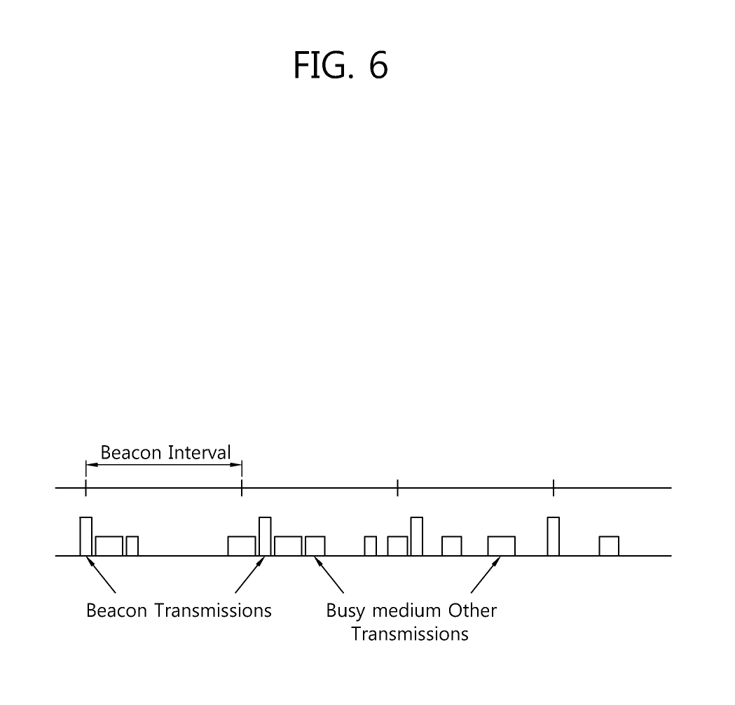

FIG. 6 shows a beacon transmission on a busy network.

Beacon generation in an infrastructure BSS is described. The AP shall define the timing for the entire BSS by transmitting beacon frames according to dot11BeaconPeriod. This defines a series of target beacon transmission times (TBTTs) exactly dot11BeaconPeriod TUs apart. The TBTT may be called a beacon interval. The beacon interval is established by the AP. Time 0 is defined to be a TBTT with the beacon frame being a delivery traffic indication message (DTIM). At each TBTT, the AP shall schedule a beacon frame as the next frame for transmission according to the medium access rules. The beacon period is included in beacon and probe response frames, and a STA shall adopt that beacon period when joining the BSS, i.e., the STA sets its dot11BeaconPeriod variable to that beacon period.

Though the transmission of a beacon frame may be delayed because of carrier sense multiple access (CSMA) deferrals, subsequent beacon frames are scheduled at the undelayed nominal beacon interval.

A method in which the AP information management entity controls the beacon transmission of the AP included in the infrastructure BSS is described. The AP information management entity may adjust the beacon interval and the beacon start point of each AP so that transmissions of beacon frames between adjacent APs managed thereby do not overlap each other. This may be applied even under a situation in which the APs are disabled to detect signals thereof

The AP information management entity may adjust the beacon interval of each AP to a lower value. For example, the AP information management entity may adjust the beacon interval of each AP to the lower value when the number of users who access the corresponding AP decreases. Alternatively, the AP information management entity may adjust the beacon interval of each AP to the lower value in order to reduce an acquisition/change delay. For example, such a case corresponds to a case in which the AP information management entity judges that the general device frequently accesses a Wi-Fi system. The acquisition delay is a time which is taken until the general device acquires system information. The change delay is a time when the AP stands by until transmitting the system information to be modified.

Alternatively, the AP information management entity may adjust the beacon interval of each AP to a higher value. For example, the AP information management entity may adjust the beacon interval of each AP to the higher value when the number of users who access the corresponding AP increases. Alternatively, the AP information management entity may adjust the beacon interval of each AP to the higher value in order to increase data efficiency. When the beacon interval is adjusted to the higher value in order to increase the data efficiency, the acquisition/change delay may increase as tradeoff. In order to solve the problem, the AP may transmit an unsolicited probe response frame. The unsolicited probe response frame may be transmitted in an event-triggered manner.

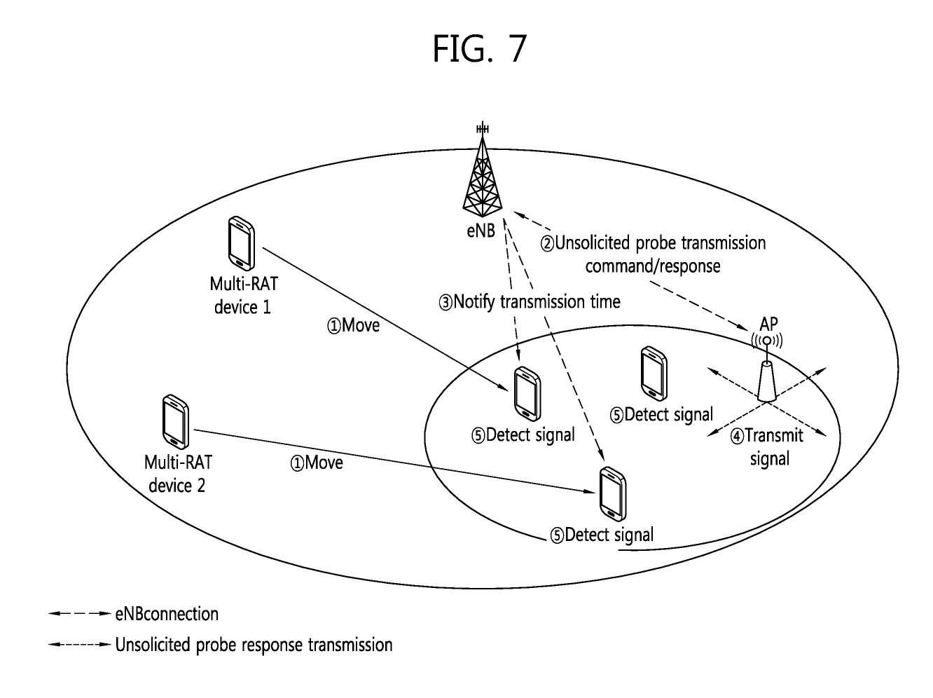

FIG. 7 shows a case in which an AP transmits an unsolicited probe response frame to decrease acquisition delay when a beacon interval of each AP is adjusted to a higher value according to an embodiment of the present invention.

1. The general device moves into the coverage of the AP.

2. The eNB, which is an AP information management entity, instructs the AP to transmit the unsolicited probe response frame, in order to decrease the acquisition delay of the general device which moves into the coverage of the AP or has already been in the coverage of the AP. The AP transmits to the eNB a response including an acceptance for the instruction of the eNB and a time point of transmission of the unsolicited probe response frame by the instruction of the eNB. In FIG. 7, it is assumed that a transmission instruction of the unsolicited probe response frame and a response thereto are transmitted through a cellular link. However, this is just exemplified, and the transmission instruction of the unsolicited probe response frame and the response thereto may be transmitted through the IP network.

3. The eNB notifies the time point of transmission of the unsolicited probe response frame of the AP to general devices in the coverage of the AP.

4. The AP transmits the unsolicited probe response frame.

5. The general devices in the coverage of the AP detect the unsolicited probe response frame.

Alternatively, the AP transmits the unsolicited probe response frame to decrease the change delay. The AP may transmit the unsolicited probe response frame including changed information when the change of the configuration is required. However, since the beacon interval is associated with a listening interval of a Wi-Fi sleep UE as well as the transmission of the beacon, the beacon interval may not be changed through the unsolicited probe response frame and may be changed only through the beacon frame.

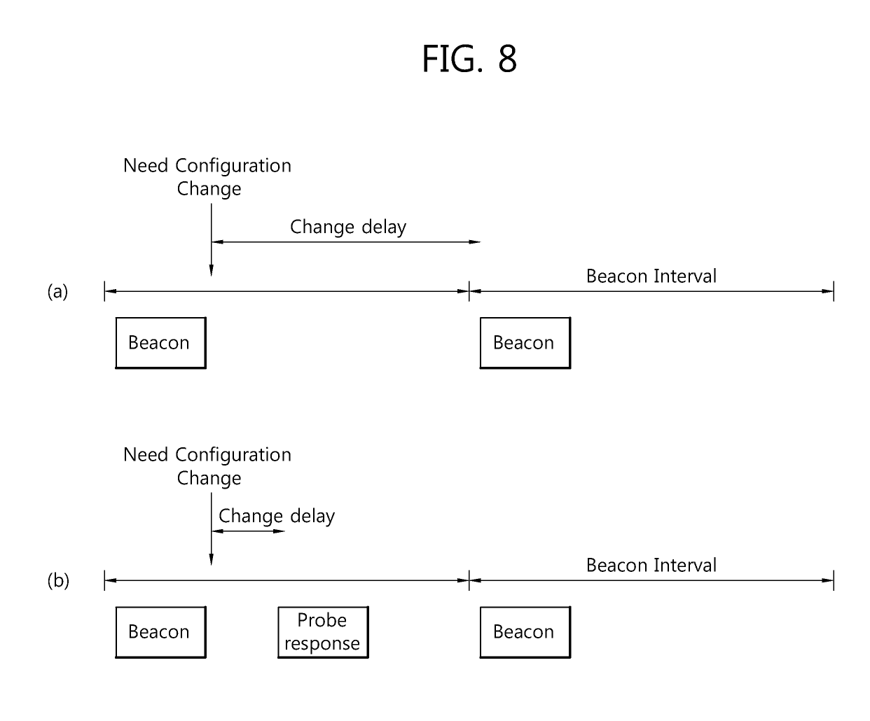

FIG. 8 shows a case in which an AP transmits an unsolicited probe response frame to decrease change delay when a beacon interval of each AP is adjusted to a higher value according to an embodiment of the present invention.

Referring to FIG. 8-(a), after the AP transmits the beacon frame at the beacon interval, the configuration change is required, but the change delay occurs until a subsequent beacon frame is transmitted at a subsequent beacon interval. Referring to FIG. 8-(b), the AP transmits the unsolicited probe response frame at the present beacon interval in order to decrease the change delay. The unsolicited probe response frame includes the changed configuration. As a result, the change delay may decrease.

First, a method for obtaining, by a cellular node which is an AP information management entity, information related to beacon transmission of an AP included in an infrastructure BSS is described.

(1) A cellular node may obtain information related to beacon transmission of an AP by using a core network (CN) interface. The AP may transmit information on a frequency channel such as an operating class, a channel number, etc., and information related to beacon transmission such as a beacon interval, etc., to an AP server, in registering to the AP server. The cellular node may obtain the information related to beacon transmission of the AP from the AP server. The cellular node may be one of an eNB, MME or new entity.

The information related to beacon transmission may further include information on a start point of the beacon interval. The start point of the beacon interval may be expressed with a Wi-Fi system timing value. Also, the information related to beacon transmission may further include an LTE system timing conversion value with respect to a Wi-Fi system timing value and an offset. The LTE system timing conversion value may be expressed with a system frame number such as a radio frame number or a subframe number, a slot number, or a symbol number, and an offset may be expressed with a unit such as us, ms, etc., or a slot number or a symbol number.

To this end, the AP should obtain timing information of the LTE system. The AP may request and obtain an LTE system timing conversion value and an offset with respect to a time point at which a general device receives a beacon, from the general device. Upon obtaining the LTE system timing conversion value and the offset with respect to the time point at which the general device receives a beacon, the AP may adjust the LTE system timing value and the offset obtained from the general device by reflecting a difference between a start point of the beacon interval and a time point at which a beacon was actually transmitted.

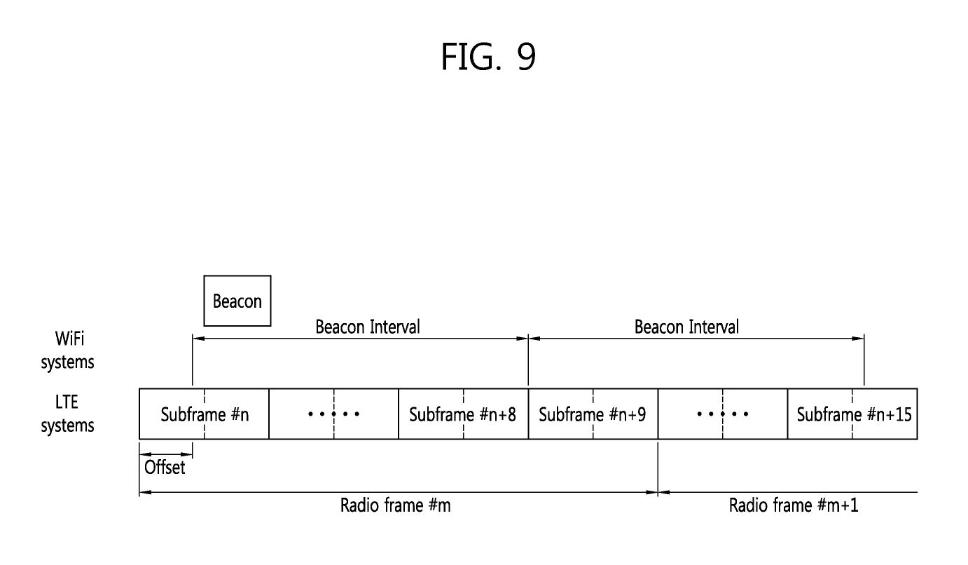

FIG. 9 shows an example of a method for obtaining a start point of a beacon interval according to an embodiment of the present invention.

Referring to FIG. 9, the general device receives a beacon at a time point at which an offset is 0.5 ms in a subframe n of a radio frame m. Thus, the general device may determine the LTE system timing conversion value and the offset as the subframe n of the radio frame m and 0.5 ms and report the same to the AP. Meanwhile, it is assumed that a difference between a start point of the beacon interval and a time point at which a beacon is actually transmitted is 0.1 ms. The AP may determine a start point of the beacon interval as a time point at which the offset is 0.4 ms in the subframe n of the radio frame m, by reflecting delay of 0.1 ms. The AP may include information on the start point of the beacon interval expressed with the LTE system timing conversion value and offset in the information related to beacon transmission and transmit the same to register the information related to beacon transmission of the AP itself to the AP server.

Alternatively, in order to obtain timing information of the LTE system, the AP may obtain a system frame number of the LTE system through a broadcast channel. In this case, it is assumed that the AP may receive a broadcast channel such as a preamble and/or a master information block (MIB) through downlink from the LTE system. The AP may obtain a system frame number of the LTE system through the MIB. Also, timing of the LTE system and that of the Wi-Fi system may be synchronized. For example, the timing of the LTE system and the timing of the Wi-Fi system may be aligned by a unit of least common multiple of a time unit of the Wi-Fi system and a subframe or slot of the LTE system.

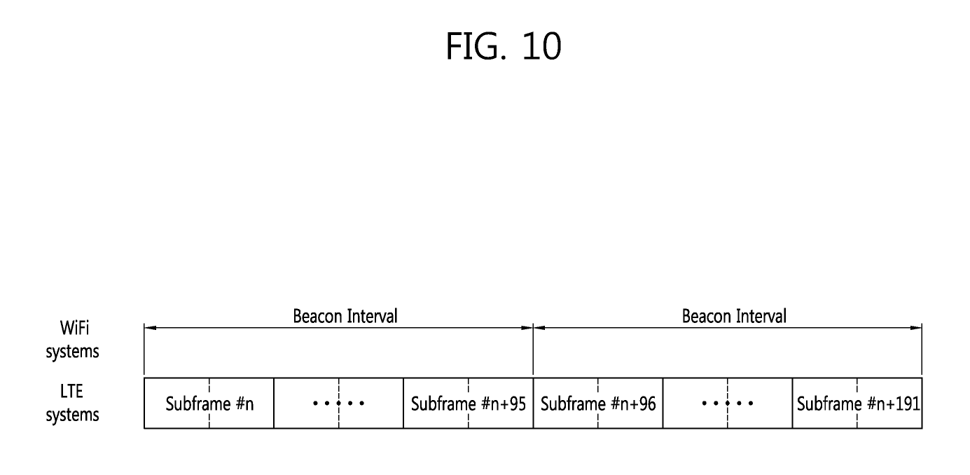

FIG. 10 shows an example of a method for obtaining a start point of a beacon interval according to another embodiment of the present invention.

Referring to FIG. 10, a start point of a beacon interval is aligned with a start point of a subframe of the LTE system. The AP may synchronize with the LTE system through a preamble, obtain a system frame number of the LTE system through a broadcast channel such as an MIB, etc., and adjust a beacon interval and a start point of a frame of the LTE system by synchronizing a timing of the LTE system and a timing of the Wi-Fi system.

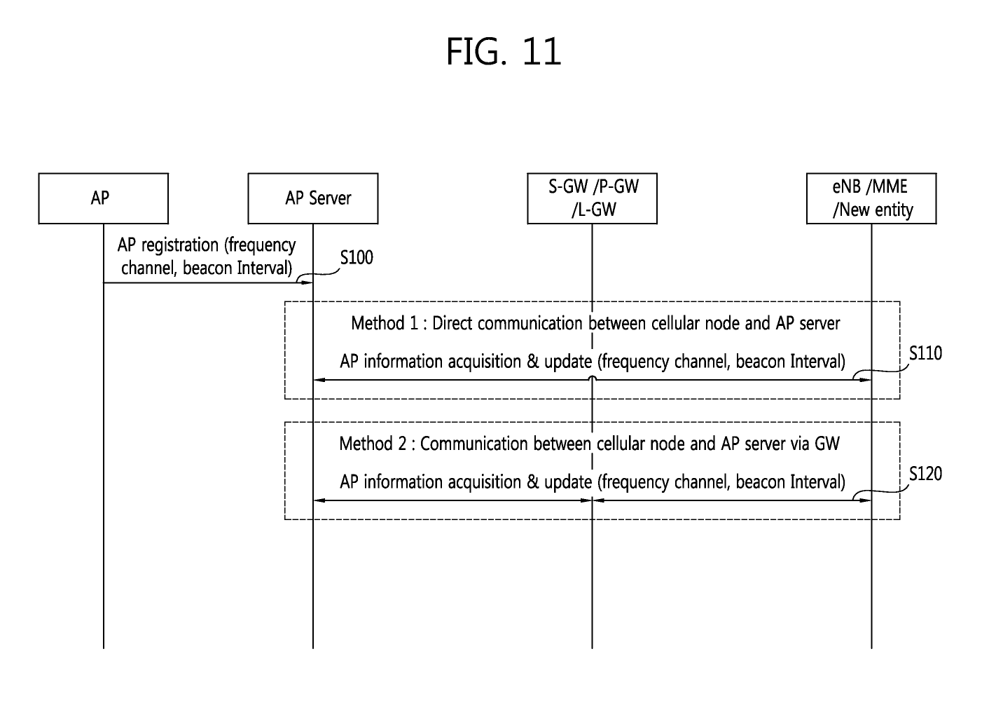

FIG. 11 shows an example of a method for obtaining information related to beacon transmission according to an embodiment of the present invention.

Referring to FIG. 11, the AP transmits information on a frequency channel such as an operating class, a channel number, etc., and information related to beacon transmission such as a beacon interval, etc., to the AP server to perform AP registration.

A cellular node, which is an AP information management entity, obtains information of APs existing within cell or eNB coverage managed by the cellular node, through the AP server. The AP information may include information on a frequency channel such as an operating class, a channel number, etc., and information related to beacon transmission such as a beacon interval, etc., and may also include an AP identifier such as a MAC address (e.g., BSSID), etc. The cellular node may be one of an eNB, MME, or new entity.

The cellular node may receive the AP information directly from the AP server or may receive the AP information through a gateway. In step S110, the cellular node receives the AP information directly from the AP server. In step S120, the cellular node receives AP information from the AP server through a gateway such as S-GW/P-GW/local gateway (L-GW), etc. Also, the cellular node may request a periodical transmission of the AP information from the AP server.

Meanwhile, in a case in which the information on a frequency channel such as an operating class, a channel number, etc., and information related to beacon transmission such as a beacon interval, etc., delivered in the process of registering the AP itself to the AP server is changed, the AP may inform the AP server accordingly. In this case, the AP may inform the AP server accordingly, although there is no request from an AP information management entity.

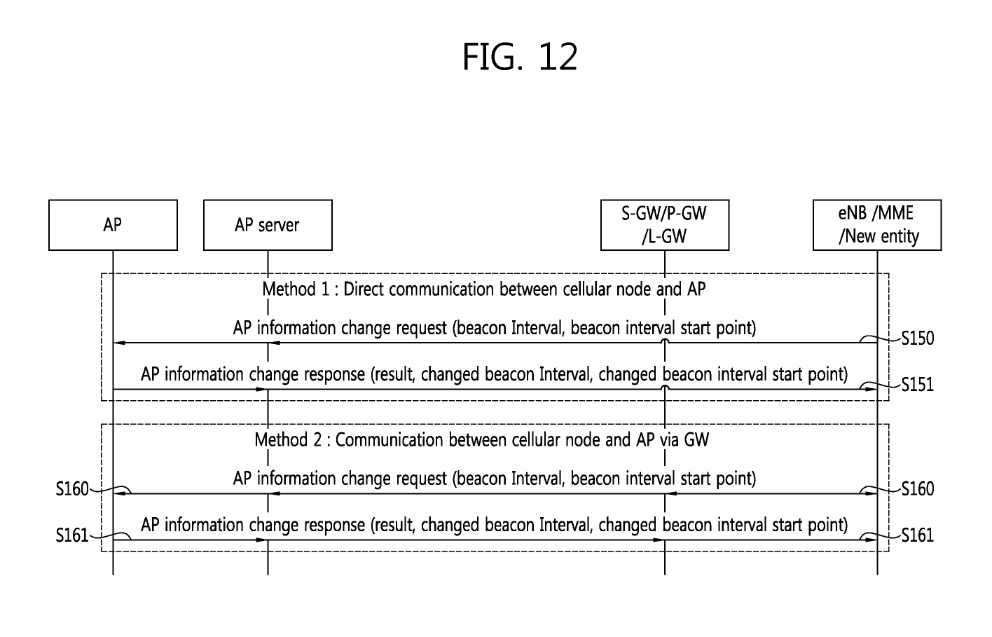

FIG. 12 shows an example of a method for controlling beacon transmission according to an embodiment of the present invention.

Referring to FIG. 12, a cellular node, which is the AP information management entity, may adjust information related to beacon transmission of each AP in coverage of a cell or eNB managed by the cellular node. The cellular node may be one of an eNB, MME, or new entity.

The cellular node may directly communicate with each AP to adjust the information related to beacon transmission of the AP. In step S150, the cellular node transmits an AP information change request to an AP server and the AP server transfers the AP information change request to each AP. The AP information change request may include the beacon interval and/or start point of the beacon interval. In step S151, each AP transmits an AP information change request to the AP server and the AP server transfers the AP information change request to the cellular node. The AP information change response may include a result for the request of the cellular node. Further, when the beacon interval and/or start point of the beacon interval is changed to a value different from a value requested by the cellular node, the AP information change response may include a changed beacon interval and/or changed start point of the beacon interval.

Alternatively, the cellular node may communicate with each AP through a gateway such as an S-GW/P-GW/L-GW, etc., to adjust the information related to beacon transmission of the AP. In step S160, the cellular node transmits the AP information change request to the S-GW/P-GW/L-GW. The S-GW/P-GW/L-GW transfers the AP information change request to each AP through the AP server. The AP information change request may include the beacon interval and/or start point of the beacon interval. In step S161, each AP transmits the AP information change response to the S-GW/P-GW/L-GW through the AP server. The S-GW/P-GW/L-GW transfers the AP information change response to the cellular node. The AP information change response may include a result for the request of the cellular node. Further, when the beacon interval and/or start point of the beacon interval is changed to a value different from a value requested by the cellular node, the AP information change response may include a changed beacon interval and/or start point of the changed beacon interval.

(2) A cellular node may obtain information related to beacon transmission of the AP by using a cellular air interface of the AP. The AP may transmit the information on a frequency channel such as an operating class, a channel number, etc., and information related to beacon transmission such as a beacon interval, etc., to the cellular node, while registering the AP itself to the cellular node, which is an AP information management entity, based on an AP identifier such as a MAC address (e.g., BSSID), etc. Thus, the cellular node may obtain the information related to beacon transmission of the AP directly from the AP. The cellular node may be one of an eNB, MME or new entity. When the cellular node is an eNB, the cellular node may obtain AP information from the AP through a cellular radio link. When the cellular node is an MME or new entity, the cellular node may obtain AP information from the AP through a cellular radio link and a network interface such as an S1 interface, etc.

The information related to beacon transmission may further include information on a start point of the beacon interval. The start point of the beacon interval may be expressed with a Wi-Fi system timing value. Also, the information related to beacon transmission may further include an LTE system timing conversion value with respect to a Wi-Fi system timing value and an offset. The LTE system timing conversion value may be expressed with a system frame number such as a radio frame number or a subframe number, a slot number, or a symbol number, and an offset may be expressed with a unit such as us, ms, etc., or a slot number or a symbol number.

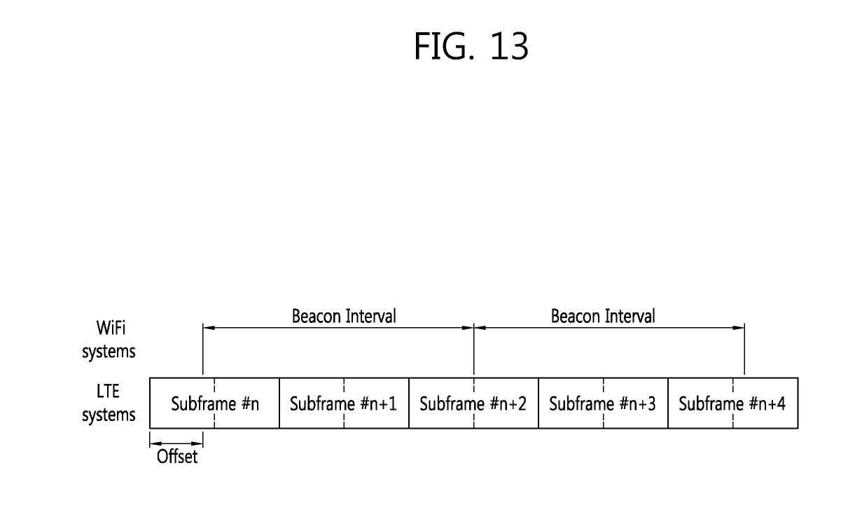

FIG. 13 shows an example of a method for obtaining a start point of a beacon interval according to another embodiment of the present invention. Referring to FIG. 13, a start point of a beacon interval is expressed with a Wi-Fi system timing value, and the Wi-Fi system timing value is expressed with a LTE system timing conversion value and an offset.

Alternatively, as described above in FIG. 10, a timing of the LTE system and that of the Wi-Fi system may be synchronized. Since it is assumed that a cellular radio link exists between the cellular node and the AP, a timing of the LTE system and that of the Wi-Fi system may be synchronized. For example, the timing of the LTE system and the timing of the Wi-Fi system may be aligned by a unit of least common multiple of a time unit of the Wi-Fi system and a subframe or slot of the LTE system. In this case, both a Wi-Fi system timing value and a LTE system conversion value may not need to be transmitted.

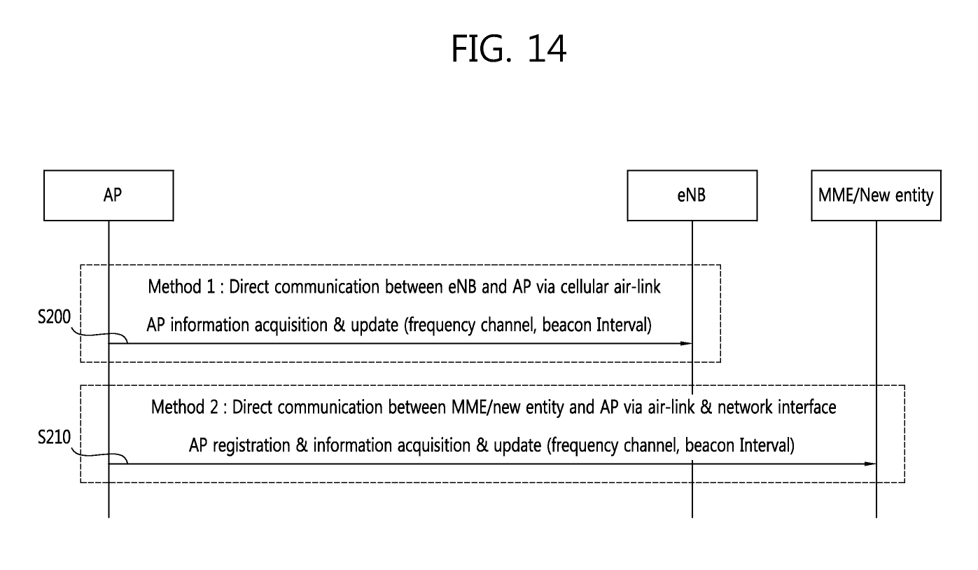

FIG. 14 shows an example of a method for obtaining information related to beacon transmission according to another embodiment of the present invention.

A cellular node, which is an AP information management entity, obtains information of APs existing within cell or eNB coverage managed by the cellular node, directly from the AP server. The AP information may include information on a frequency channel such as an operating class, a channel number, etc., and information related to beacon transmission such as a beacon interval, etc. Also, the AP information may include an AP identifier such as a MAC address (e.g., BSSID), etc.

The cellular node may be one of eNB, MME, or new entity. Referring to FIG. 14, in step S200, the AP transmits the information on a frequency channel such as an operating class, a channel number, etc., and information related to beacon transmission such as a beacon interval, etc., to the eNB through a cellular radio link, and registers the AP itself to the eNB. Alternatively, in step S210, the AP transmits the information on a frequency channel such as an operating class, a channel number, etc., and information related to beacon transmission such as a beacon interval, etc., to an MME or new entity through a cellular radio link and network interface and registers the AP itself to the MME or new entity. Also, the cellular node may request a periodical transmission of the AP information from the AP.

Meanwhile, in a case in which the information on a frequency channel such as an operating class, a channel number, etc., and information related to beacon transmission such as a beacon interval, etc., delivered in the process of registering the AP itself to the cellular node, which is an AP information management entity, is changed, the AP may inform the cellular node accordingly. In this case, the AP may inform the cellular node accordingly, although there is no request from an AP information management entity.

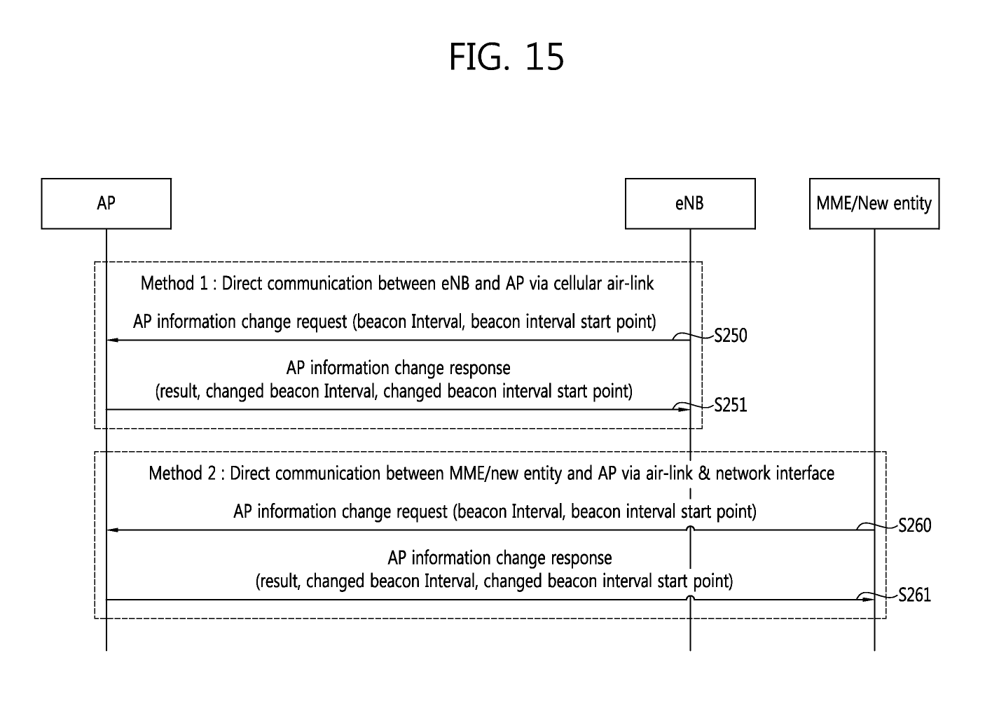

FIG. 15 shows an example of a method for controlling beacon transmission according to another embodiment of the present invention.

Referring to FIG. 15, the cellular node, which is the AP information management entity, may adjust the information related to beacon transmission of each AP in the coverage of the cell or eNB managed by the cellular node. The cellular node may be one of an eNB, MME, or new entity.

The cellular node may directly communicate with the AP to adjust the information related to beacon transmission of the AP. In step S250, the eNB, which is the AP information management entity, transmits the AP information change request to the AP through a cellular air link. Alternatively, in step S260, the MME or new entity, which is the AP information management entity, transmits the AP information change request to the AP through the cellular air link and a network interface such as an S1 interface, etc. The AP information change request may include the beacon interval and/or start point of the beacon interval. In step S251, the AP transmits the AP information change response to the eNB, which is the AP information management entity, through the cellular air link. Alternatively, in step S261, the AP transmits the AP information change response to the MME or new entity, which is the AP information management entity, through the cellular air link and the network interface such as the S1 interface, etc. The AP information change response may include the result for the request of the cellular node. Further, when the beacon interval and/or start point of the beacon interval is changed to a value different from a value requested by the cellular node, the AP information change response may include a changed beacon interval and/or start point of the changed beacon interval.

(3) A cellular node may obtain information related to beacon transmission of the AP by using a cellular air interface of a general device. The AP may transmit a beacon or probe message, and upon receiving the same, the general device may transmit information on a frequency channel such as an operating class, a channel number, etc., and information related to beacon transmission such as a beacon interval, etc., to the cellular node, which is an AP information management entity, while registering the AP to the cellular node based on an AP identifier such as a MAC address (e.g., BSSID), etc. Thus, the cellular node may obtain the information related to beacon transmission of the AP through the general device. The cellular node may be one of an eNB, MME, or new entity. When the cellular node is an eNB, the cellular node may obtain AP information from the AP through a cellular radio link. When the cellular node is an MME or new entity, the cellular node may obtain AP information from the general device through a cellular radio link and a network interface such as an S1 interface, etc.

The information related to beacon transmission may further include information on a start point of the beacon interval. The start point of the beacon interval may be expressed with a Wi-Fi system timing value. Also, the information related to beacon transmission may further include an LTE system timing conversion value with respect to a Wi-Fi system timing value and an offset. The LTE system timing conversion value may be expressed with a system frame number such as a radio frame number or a subframe number, a slot number, or a symbol number, and an offset may be expressed with a unit such as us, ms, etc., or a slot number or a symbol number. A method for obtaining a start point of a beacon interval has been described above referring to FIG. 13

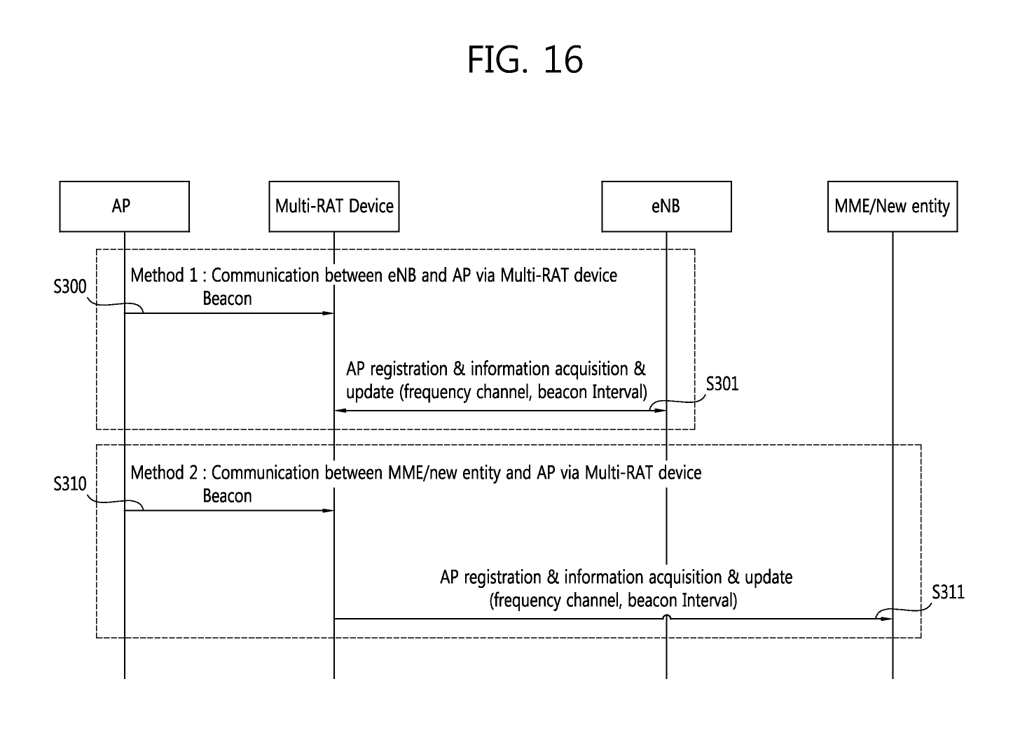

FIG. 16 shows an example of a method for obtaining information related to beacon transmission according to another embodiment of the present invention.

A cellular node, which is an AP information management entity, obtains information of APs existing within cell or eNB coverage managed by the cellular node, from a general device. The general device may be a multi-RAT device supporting a plurality of RATs. The AP information may include information on a frequency channel such as an operating class, a channel number, etc., and information related to beacon transmission such as a beacon interval, etc. Also, the AP information may include an AP identifier such as a MAC address (e.g., BSSID), etc.

The cellular node may be one of an eNB, MME or new entity. Referring to FIG. 16, in step S300, the multi-RAT device receives a beacon from an AP, and in step S301, the multi-RAT device transmits the information on a frequency channel such as an operating class, a channel number, etc., and information related to beacon transmission such as a beacon interval, etc., to the eNB through a cellular radio link, and registers the AP to the eNB. Alternatively, in step S310, the multi-RAT device receives a beacon from the AP, and in step S311, the multi-RAT device transmits the information on a frequency channel such as an operating class, a channel number, etc., and information related to beacon transmission such as a beacon interval, etc., to an MME or new entity through a cellular radio link and a network interface and registers the AP to the MME or new entity.

Meanwhile, in a case in which the information on a frequency channel such as an operating class, a channel number, etc., and information related to beacon transmission such as a beacon interval, etc., delivered in the process of registering, by a general device, the AP to the cellular node, which is an AP information management entity, is changed, the general device may inform the cellular node accordingly. In this case, the general device may inform the cellular node accordingly, although there is no request from an AP information management entity.

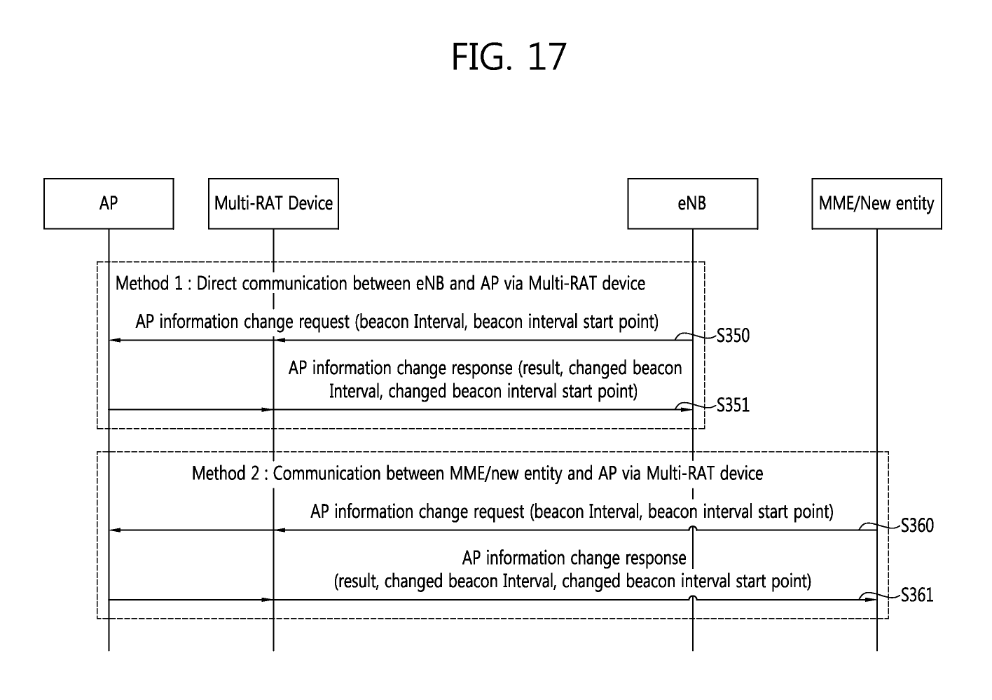

FIG. 17 shows an example of a method for controlling beacon transmission according to another embodiment of the present invention.

Referring to FIG. 17, a cellular node, which is the AP information management entity, may adjust information related to beacon transmission of each AP in coverage of a cell or eNB managed by the cellular node. The cellular node may be one of an eNB, MME, or new entity.

The cellular node may adjust the information related to beacon transmission of the AP through the general device. In step S350, the eNB, which is the AP information management entity, transmits the AP information change request to the general device through the cellular air link and the general device transfers the AP information change request to each AP. Alternatively, in step S360, the MME or new entity, which is the AP information management entity, transmits the AP information change request to the general device through the cellular air link and the network interface such as an S1 interface, etc., and the general device transfers the AP information change request to each AP. The AP information change request may include the beacon interval and/or start point of the beacon interval. In step S351, the AP transmits the AP information change response to the general device through the cellular air link and the general device transfers the AP information change response to each eNB which is the AP information management entity. Alternatively, in step S261, the AP transmits the AP information change request to the general device through the cellular air link and the network interface such as the S1 interface, etc., and the general device transfers the AP information change response to the MME or new entity which is the AP information management entity. The AP information change response may include the result for the request of the cellular node. Further, when the beacon interval and/or start point of the beacon interval is changed to a value different from a value requested by the cellular node, the AP information change response may include a changed beacon interval and/or changed start point of the beacon interval.

A method for transmitting obtained information related to beacon transmission to a general device is described.

A cellular node, which is an AP information management entity, transmits AP information through a cellular network. The AP information may include information on a frequency channel such as an operating class, a channel number, etc., and information related to beacon transmission such as a beacon interval, etc. Also, the AP information may include an AP identifier such as a MAC address (e.g., BSSID), etc. The cellular node may be one of an eNB, MME, or new entity.

The cellular node may transmit only AP information of APs adjacent to the corresponding general device. Also, a start point of a beacon interval among the information to be transmitted may be set as a value in the nearest future at which the corresponding general device can receive a beacon. For example, in a case in which a length of a beacon interval is 1.024*1000 ms, a start point of the beacon interval is an offset 0.4 ms in a subframe n of a radio frame m, and a current system frame number is a radio frame (m+91), a start point of the beacon interval to be transmitted to the general device may be determined as a time point of offset 0.4 ms in a subframe (n+4) of a radio frame (m+102).

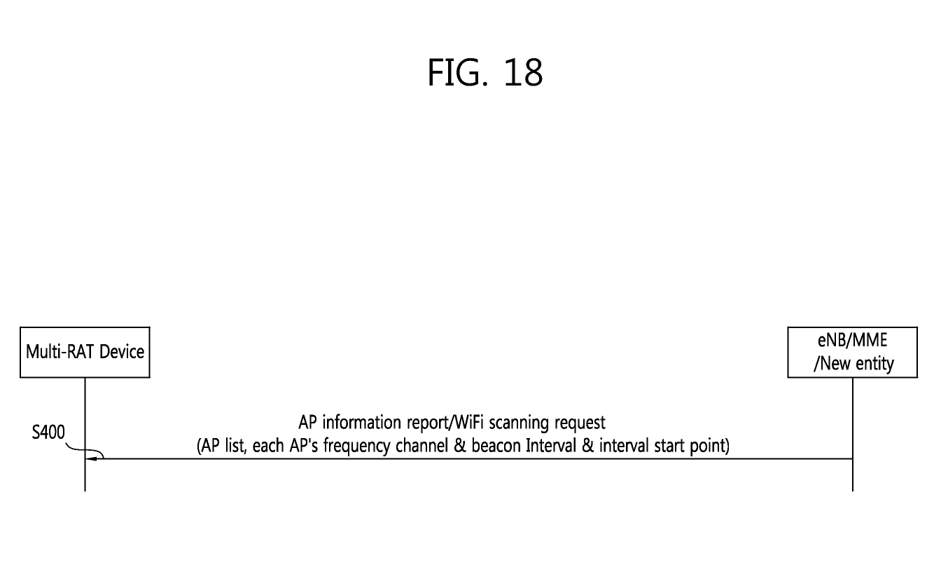

FIG. 18 shows an example of a method for transmitting information related to beacon transmission according to an embodiment of the present invention. In step S400, a cellular node, which is an AP information management entity, transmits AP information report or Wi-Fi scanning request message to a multi-RAT device. The AP information report or Wi-Fi scanning request message may include information on a frequency channel such as an operating class, a channel number, etc., and information related to beacon transmission such as a beacon interval, etc. Also, the AP information may include an AP identifier such as MAC address (e.g., BSSID), etc.

Upon receiving the information related to beacon transmission, the general device may optimize Wi-Fi access by using the corresponding information. In detail, a time required for perform scanning and obtaining Wi-Fi system information may be reduced. For a Wi-Fi access, the general device needs to first perform scanning to obtain system information, and in the prior art, at which time point a beacon including Wi-Fi system information is transmitted cannot be known, so the general device should continue to perform monitoring until when a beacon is received.

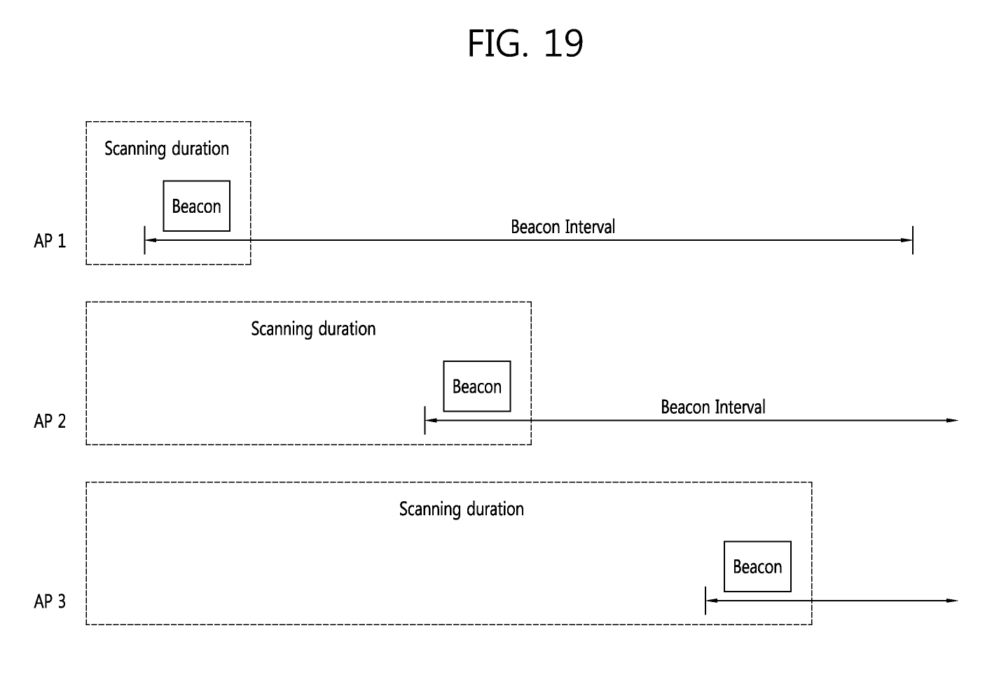

FIG. 19 shows scanning durations when a general device performs scanning according to a conventional method. Referring to FIG. 19, in case of an AP1, since a beacon interval starts relatively early, the general device may perform scanning relatively briefly until when a beacon transmitted from the AP1 is received. In comparison, in case of AP2 and AP3, since beacon intervals start late, the general device should perform scanning on frequency channels for a long period of time until when a beacon transmitted from the AP2 and AP3 is received. Namely, the general device cannot know at which time point a beacon is transmitted and which of the APs transmits a beacon, so it should continuously perform scanning on frequency channels until when a beacon is received at least once.

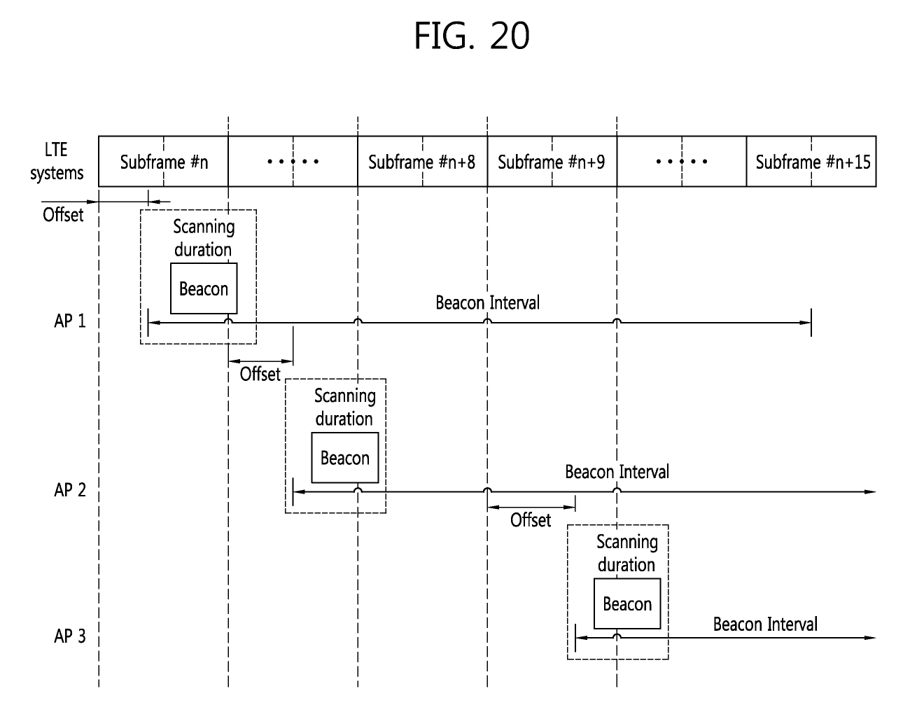

FIG. 20 shows scanning durations when a general device performs scanning according to an embodiment of the present invention. Referring to FIG. 20, start points of beacon intervals of respective APs are different, and a start point of a beacon interval of each AP may be expressed with a system frame number of LTE system and an offset, respectively. According to the embodiment of the present invention, in a case in which a general device obtains information related to beacon transmission from a cellular node, which is an AP information management device, the general device may know at which time point each AP transmits a beacon. Thus, a scanning duration in which the general device performs scanning to receive a beacon transmitted from each AP may be set to be different. The general device may determine optimal AP scanning order according to a start point of a beacon interval of each AP. The general device may perform scanning according to a time point at which each AP transmits a beacon, and thus, a time required for the general device to perform scanning and obtaining Wi-Fi system information may be reduced.

Hereinafter, a method in which a primary RAT system controls beacon transmission of a general device of a secondary RAT system included in an independent BSS is described. That is, a method in which the primary RAT system collects and/or controls information related to beacon transmission of the general device such as a UE, etc., and notifies the collected and/or controlled information to other general devices to optimize the direct secondary RAT system access among the general devices is described. The primary RAT system needs to determine whether the general device in the coverage thereof can operate in the secondary RAT system. Accordingly, the general device may notify its own information for the secondary RAT system which is operable to the cellular node (e.g., eNB or MME). The information of the general device, which is transmitted by the general device, may include information an MAC address (e.g., BSSID), information on a frequency channel such as an operating class, a channel number, etc., and information related to beacon transmission such as a beacon interval in the independent BSS, etc. In this case, the cellular node may control and/or adjust a system configuration of the secondary RAT system such as a beacon interval, start point o the beacon interval, etc., of the general device that is positioned in coverage thereof. The cellular node notifies the obtained information related beacon transmission of the general device to other general devices to optimize a direct secondary RAT system access procedure among the general devices.

Hereinafter, for convenience of the description, it is assumed that the primary RAT system is a 3GPP LTE (or 3GPP LTE-A) which is a cellular system, and the secondary RAT system an IEEE 802.11 (Wi-Fi) which is a WLAN system. However, the embodiment of the present invention is not limited thereto. When the primary RAT system is a 3GPP LTE(-A), the AP information management entity of a primary RAT system may be one of an eNB, MME or new entity.

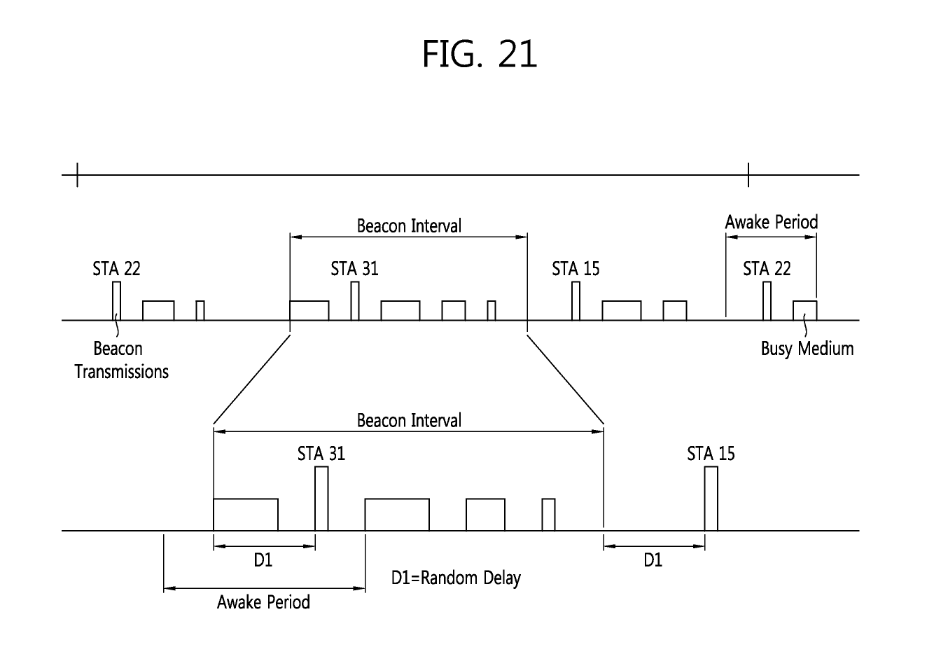

FIG. 21 shows a beacon transmission in an independent BSS.

Beacon generation in an independent BSS is described. Beacon generation in an independent BSS is distributed. The beacon period is included in beacon and probe response frames, and STAs shall adopt that beacon period when joining the independent BSS. All members of the independent BSS participate in beacon generation. Each STA shall maintain its own timer synchronization function (TSF) timer that is used for dot11BeaconPeriod timing. The beacon interval within the independent BSS is established by the STA at which the MLME-START.request primitive is performed to create the independent BSS. This defines a series of TBTTs exactly dot11BeaconPeriod TUs apart. Time zero is defined to be a TBTT. At each TBTT the STA shall

a) Suspend the decrementing of the backoff timer for any pending non-Beacon transmission,
b) Calculate a random delay uniformly distributed in the range between zero and twice aCWmin×aSlotTime,
c) Wait for the period of the random delay, decrementing the random delay timer using the same algorithm as for backoff,
d) Cancel the remaining random delay and the pending beacon frame transmission, if a beacon frame arrives from the independent BSS of which the STA is a member before the random delay timer has expired,
e) Send a beacon frame if the random delay has expired and no beacon frame has arrived from the independent BSS of which the STA is a member during the delay period,
f) If the ad-hoc traffic indication message (ATIM) window in use within the independent BSS is greater than 0, then 1) resume decrementing the backoff timer for any pending transmission allowed inside the ATIM window, and 2) At the end of the ATIM window duration resume the backoff for any pending frames intended for transmission outside the ATIM window,
g) If the ATIM window in use within the independent BSS is 0, then resume decrementing the backoff timer for any pending transmissions.

A STA that has joined an IBSS shall transmit Beacon frames only during the awake period of the IBSS.

A method in which the cellular node controls Wi-Fi activation of a general device included in an independent BSS is described. In more detail, the cellular node may control on/off of a Wi-Fi RF of a special-purpose device managed by the cellular node, in order to minimize power consumption and interference of the general device. The special-purpose device may be one of a source device, a cooperative device, and a cooperative candidate device that perform a client operation or a device-to-device (D2D) device that performs D2D communication.

The cellular node may transmit to the special-purpose device a Wi-Fi activation request including an action to be performed by the special-purpose device, frequency band information, request reason, a randomization interval, measurement duration, time point of Wi-Fi on/off, etc. The action may include Wi-Fi RF on, Wi-Fi RF off, Wi-Fi beacon transmission, Wi-Fi beacon suspension, etc. The action may be configured in a bitmap form, and as a result, one Wi-Fi activation request may instruct that various actions will be performed. The frequency band information represents a frequency band in which the corresponding special-purpose device will operate. The frequency band information may include a (global) operating class including a channel starting frequency, channel spacing, a channel set, etc., and channel number.

The request reason may be generally classified into two types. Reason 1 indicates a case in which the client operation or the D2D communication using Wi-Fi is required. When the request reason is reason 1, the frequency band may be indicated as a frequency having a small interference amount. Reason 2, as information used to select an operating frequency, indicates a case in which the interference amount is to be measured. When the request reason is reason 2, the frequency band may be indicated as a frequency to be measured. The randomization interval indicates an upper bound of the random delay and may be included only when the request reason is reason 2. The measurement duration may also be included only when the request reason is reason 2.

The special-purpose device that receives the Wi-Fi activation request from the cellular node performs the action depending on the request reason. When the request reason is reason 1, the special-purpose device performs a general Wi-Fi operation. When the request reason is reason 2, the special-purpose device performs an operation after receiving a channel load request defined in the known IEEE 802.11 specification. However, a measurement report is transmitted to the cellular node through a cellular network.

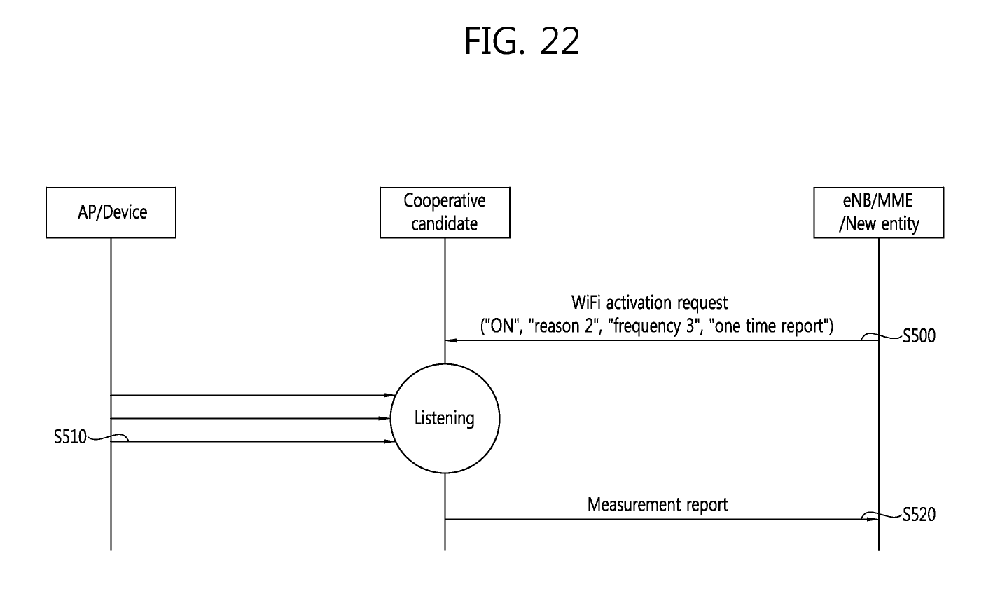

FIG. 22 shows an example of a method for controlling Wi-Fi activation of a special-purpose device according to an embodiment of the present invention.

In step S500, the cellular node transmits the Wi-Fi activation request to the cooperative candidate device. The Wi-Fi activation request may include an action set to Wi-Fi RF on, reason set to reason 2, frequency band information set to frequency 3, etc. Further, the Wi-Fi activation request may instruct that the measurement report will be reported only once.

In step S510, the cooperative candidate device that receives the Wi-Fi activation request turns on the Wi-Fi RF at frequency 3 and listens to a signal transmitted from the AP or another device. In step S520, the cooperative candidate device transmits the measurement report for frequency 3 to the cellular node.

A method in which a cellular node controls beacon transmission of a special-purpose device included in an independent BSS is described. As a result, power consumption of the special-purpose device may be minimized. The cellular node may request starting beacon transmission to the special-purpose device under a situation in which passive scanning for the client operation or the D2D communication is required. If the request is not required any longer, the cellular node may request stopping the beacon transmission to the special-purpose device.

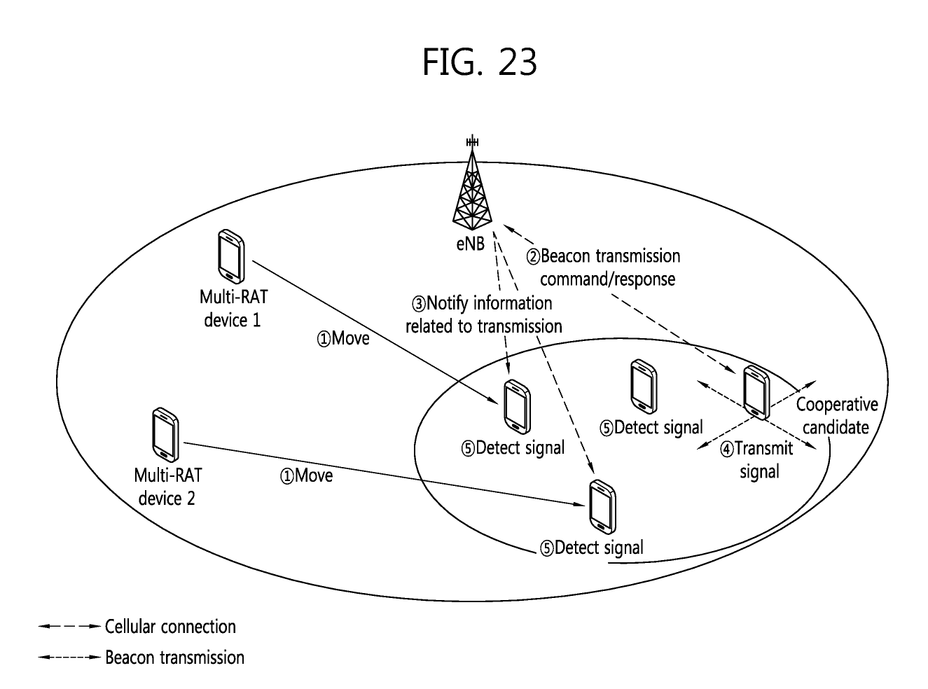

FIG. 23 shows an example of a method for controlling, by a cellular node, beacon transmission of a special-purpose device according to an embodiment of the present invention.

1. The general device moves into a BSS of the cooperative candidate device.
2. The eNB instructs the cooperative candidate device to transmit the beacon. The cooperative candidate device transmits to the eNB a response including an acceptance for the instruction from the eNB and a time point of transmission of the beacon by the instruction of the eNB
3. The eNB notifies the time point of transmission of the beacon of the cooperative candidate device to general devices in the corresponding BSS.
4. The cooperative candidate device transmits the beacon at the corresponding time point of transmission.
5. The general devices in the BSS detect the beacon.

Further, the cellular node may adjust configurations such as a beacon interval and start point of the beacon interval of the special-purpose device through the cellular air interface. The cellular node transmits a message including the beacon interval and start point of the beacon interval to special-purpose devices having the same BSSID to adjust the beacon intervals of the special-purpose devices. Further, the cellular node may notify even time point when the adjusted beacon interval is applied. The corresponding message may be transmitted in a multicast manner.

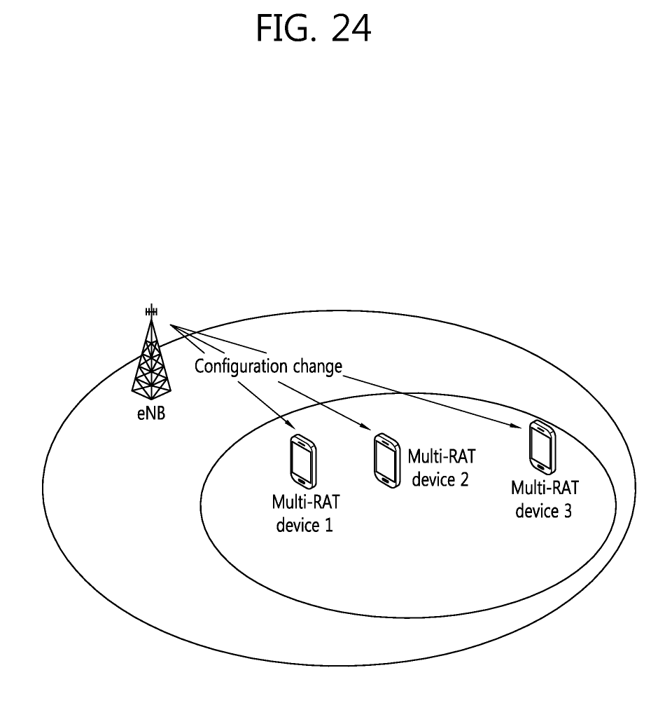

FIG. 24 shows an example of a method for controlling, by a cellular node, beacon transmission of a special-purpose device according to another embodiment of the present invention. Referring to FIG. 24, the eNB transmits a configuration change including the beacon interval and start point of the beacon interval to respective devices through a cellular connection. As a result, beacon transmission of each device may be adjusted.

The cellular node may adjust a beacon interval of the special-purpose device to a lower value. For example, the cellular node may adjust the beacon interval of the special-purpose device to the lower value when the number of users in the BSS. Alternatively, the cellular node may adjust the beacon interval of the special-purpose device to the lower value in order to reduce an acquisition/change delay. For example, such a case corresponds to a case in which the cellular node judges that the general device frequently accesses a Wi-Fi system. The acquisition delay is a time which is taken until the general device acquires system information. The change delay is a time when the general device stands by until transmitting the system information to be modified.

Alternatively, the cellular node may adjust a beacon interval of the special-purpose device to a higher value. For example, the cellular node may adjust the beacon interval of the special-purpose device to the higher value when the number of users who access the corresponding special-purpose device increases. Alternatively, the cellular node may adjust the beacon interval of the special-purpose device to the higher value in order to increase data efficiency. When the beacon interval is adjusted to the higher value in order to increase the data efficiency, the acquisition/change delay may increase as tradeoff. In order to solve the problem, the special-purpose device, which is to change configurations or by a request of the cellular node, may transmit an unsolicited probe response frame. The unsolicited probe response frame may be transmitted in an event-triggered manner.

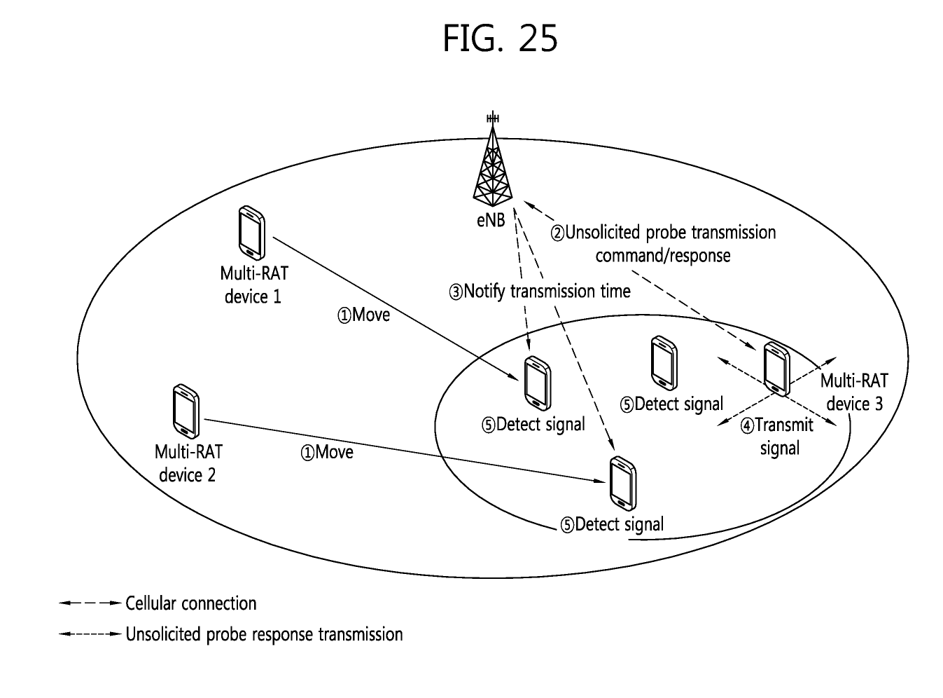

FIG. 25 shows a case in which a special-purpose device transmits an unsolicited probe response frame to decrease acquisition delay when a beacon interval of the special-purpose device is adjusted to a higher value according to an embodiment of the present invention.

1. The general device moves into the BSS of another general device.
2. The eNB instructs the multi-RAT device 3 to transmit the unsolicited probe response frame, in order to decrease the acquisition delay of general devices which move into the BSS or has already been in the BSS. The multi-RAT device 3 transmits to the eNB a response including an acceptance for the instruction of the eNB and a time point of transmission of the unsolicited probe response frame by the instruction of the eNB. In FIG. 25, it is assumed that a transmission instruction of the unsolicited probe response frame and a response thereto are transmitted through a cellular link. However, this is just exemplified, and the transmission instruction of the unsolicited probe response frame and the response thereto may be transmitted through the IP network.
3. The eNB notifies the time point of transmission of the unsolicited probe response frame of the multi-RAT device 3 to general devices in the corresponding BSS.
4. The multi-RAT device 3 transmits the unsolicited probe response frame at the corresponding time point of transmission.
5. The general devices in the corresponding BSS detect the unsolicited probe response frame.

Alternatively, the special-purpose device transmits the unsolicited probe response frame to decrease the change delay. It may be referred to FIG. 8 described above. The special-purpose device may transmit the unsolicited probe response frame including changed information when the change of the configuration is required. However, since the beacon interval is associated with a listening interval of a Wi-Fi sleep UE as well as the transmission of the beacon, the beacon interval may not be changed through the unsolicited probe response frame and may be changed only through the beacon frame.

According to the embodiment of the present invention, as the cellular node controls the beacon transmission of each special-purpose device, the random delay defined in the known IEEE 802.11 specification is not required. The cellular node may notify to each device at which beacon interval the beacon needs to be transmitted so that the beacon transmissions among the devices do not overlap each other. Further, only one device that selects the shortest random delay at one beacon interval may transmit the beacon in the prior art, but according to the embodiment of the present invention, the cellular node may control the beacon transmissions of the respective devices not to overlap each other without such a restriction.

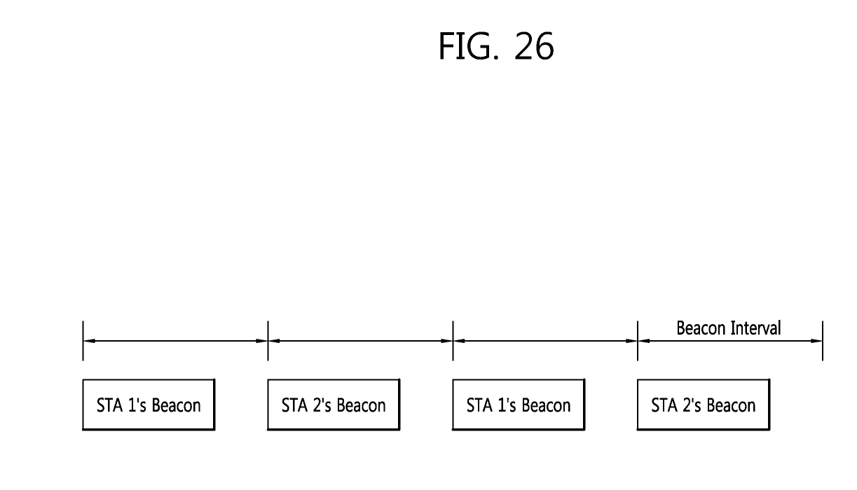

FIG. 26 shows an example of a method for controlling, by a cellular node, beacon transmission of a special-purpose device according to another embodiment of the present invention. Referring to FIG. 26, the cellular node instructs device 1 to transmit the beacon at offset 0 of an odd-numbered beacon interval and further, instructs device 2 to transmit the beacon at offset 0 of an even-numbered beacon interval. Since the cellular node notifies to the devices having the same BSSID which device will transmit the beacon at a specific time point, the corresponding devices do not request resource occupation (e.g., request to send (RTS)) at the time point when another device having the same BSSID transmits the beacon. In this case, due to the resource occupation by another device, beacon transmission by a predetermined device may be postponed.

A method for obtaining and controlling, by a cellular node, information related to beacon transmission of a general device included in an independent BSS is described.

(1) The general device transmits its own information to the cellular node which is an entity managing information of the Wi-Fi system. The information to be transmitted may include an MAC address of the Wi-Fi system. The cellular node may be one of an eNB, MME or new entity. When the cellular node is an eNB, the cellular node may obtain information of the general device through a cellular radio link. When the cellular node is an MME or new entity, the cellular node may obtain information of the general device through a cellular radio link and a network interface such as an S1 interface, etc. Also, the cellular node may request a periodical transmission of the information of the general device, from the general device.

The general device, which generates the BSS, may transmit its own information including information on a frequency channel such as an operating class, a channel number, etc., and information related to beacon transmission such as a beacon interval, etc. The information related to beacon transmission may further include information on a start point of the beacon interval. The start point of the beacon interval may be expressed with a Wi-Fi system timing value. Also, the information related to beacon transmission may further include an LTE system timing conversion value with respect to a Wi-Fi system timing value and an offset. The LTE system timing conversion value may be expressed with a system frame number such as a radio frame number or a subframe number, a slot number, or a symbol number, and an offset may be expressed with a unit such as us, ms, etc., or a slot number or a symbol number. It may be referred to FIG. 13 described above.

Alternatively, as described above in FIG. 10, a timing of the LTE system and that of the Wi-Fi system may be synchronized. Since it is assumed that a cellular radio link exists between the cellular node and the general device, a timing of the LTE system and that of the Wi-Fi system may be synchronized. For example, the timing of the LTE system and the timing of the Wi-Fi system may be aligned by a unit of least common multiple of a time unit of the Wi-Fi system and a subframe or slot of the LTE system. In this case, both a Wi-Fi system timing value and a LTE system conversion value may not need to be transmitted.

Meanwhile, in a case in which the information on a frequency channel such as an operating class, a channel number, etc., and information related to beacon transmission such as a beacon interval, etc., delivered in the process of registering the general device itself to the cellular node is changed, the general device may inform the cellular node accordingly. In this case, the general device may inform the cellular node accordingly, although there is no request from the cellular node.

(2) A first device transmits system information through a beacon or probe message according to the prior art. Upon receiving the beacon or probe message, a second general device transmits obtained information of the first general device to the cellular node which is an entity managing information of the Wi-Fi system. The information to be transmitted may include an MAC address of the Wi-Fi system. The cellular node may be one of an eNB, MME or new entity. When the cellular node is an eNB, the cellular node may obtain information of the first general device through a cellular radio link. When the cellular node is an MME or new entity, the cellular node may obtain information of the first general device through a cellular radio link and a network interface such as an S1 interface, etc. Also, the cellular node may request a periodical transmission of the information of the first general device, from the second general device.

The second general device may transmit information of the first general device including information on a frequency channel such as an operating class, a channel number, etc., and information related to beacon transmission such as a beacon interval, etc. The information related to beacon transmission may further include information on a start point of the beacon interval. The start point of the beacon interval may be expressed with a Wi-Fi system timing value. Also, the information related to beacon transmission may further include an LTE system timing conversion value with respect to a Wi-Fi system timing value and an offset. The LTE system timing conversion value may be expressed with a system frame number such as a radio frame number or a subframe number, a slot number, or a symbol number, and an offset may be expressed with a unit such as us, ms, etc., or a slot number or a symbol number. It may be referred to FIG. 13 described above.

Meanwhile, in a case in which the information on a frequency channel such as an operating class, a channel number, etc., and information related to beacon transmission such as a beacon interval, etc., of the first general device is changed, the second general device may inform the cellular node accordingly. In this case, the second general device may inform the cellular node accordingly, although there is no request from the cellular node.

The cellular node may adjust information related to beacon transmission of each general device in coverage of a cell or eNB managed by the cellular node. The cellular node may be one of an eNB, MME, or new entity. When the cellular node is an eNB, the cellular node may adjust the information of each general device through a cellular radio link. When the cellular node is an MME or new entity, the cellular node may adjust the information of each general device through a cellular radio link and a network interface such as an S1 interface, etc. When the beacon interval and/or start point of the beacon interval is changed to a value different from a value requested by the cellular node, each general device may transmit a response message including a changed beacon interval and/or changed start point of the beacon interval.

A method of transmitting, by a cellular node, obtained information related to beacon transmission to a general device is described. The cellular node transmits information on another general device to the general device that intends to access a Wi-Fi system through the cellular network. Information on the general device may include an MAC address of the Wi-Fi system. Further, the information on the general device may include information on a frequency channel such as an operating class, a channel number, etc., and information related to beacon transmission such as a beacon interval, etc. The cellular node may be one of an eNB, MME, or new entity.

The cellular node may transmit only information on a general device adjacent to the general device that intends to access the corresponding Wi-Fi system. Further, the cellular node may transmit both a BSSID of the corresponding adjacent general device and information on another general device that belongs to the corresponding BSS. Through a time point of beacon transmission of each general device that belongs to a specific BSS, the general device that intends to access the Wi-Fi system may know beacon transmission schedules of other general devices of the corresponding BSS.

Further, a start point of a beacon interval among the information to be transmitted may be set as a value in the nearest future at which the corresponding general device can receive a beacon. For example, in a case in which a length of a beacon interval is 1.024*1000 ms, a start point of the beacon interval is an offset 0.4 ms in a subframe n of a radio frame m, and a current system frame number is a radio frame (m+91), a start point of the beacon interval to be transmitted to the general device may be determined as a time point of offset 0.4 ms in a subframe (n+4) of a radio frame (m+102).

In the prior art, it is decided which device will transmit the beacon at every beacon interval. That is, according to the random delay which each device in the same BSS selects, only a device having a small random delay may transmit the beacon at one beacon interval. However, according to the present invention, as the cellular system controls each device to transmit the beacon, a contention based resource occupation procedure is not required. Each device do not overlap each other to transmit the beacon. Further, since a cellular system may instruct the access of the general device to a WLAN system only under a situation in which cooperative communication or direct communication is required, an unnecessary access time and unnecessary power consumption of the general device may be minimized.

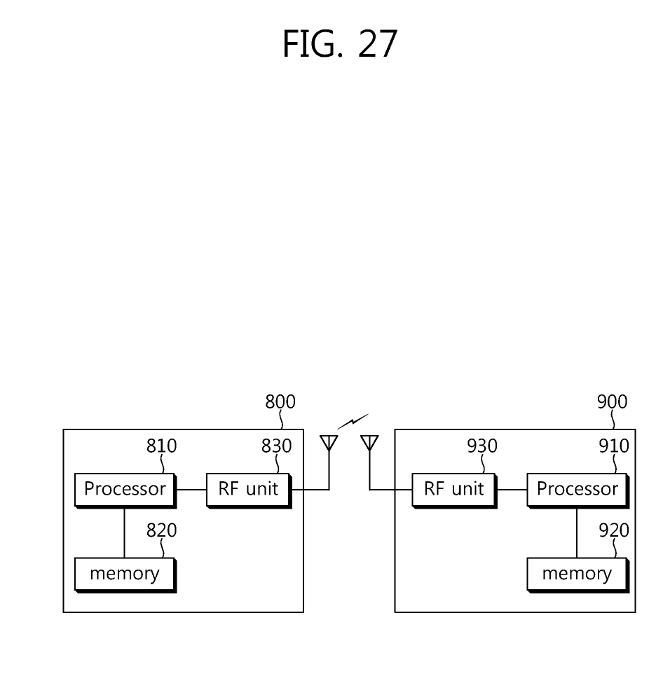

FIG. 27 is a block diagram showing wireless communication system to implement an embodiment of the present invention.

A cellular node 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An AP or general device 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for controlling, by a node of a primary radio access technology (RAT) system, beacon transmission in a wireless communication system, the method comprising:
adjusting an beacon interval of a plurality of access points (APs) of a secondary RAT system and a start point of the beacon interval of the plurality of APs so that beacon transmissions of the plurality of APs do not overlap each other,
wherein the plurality of APs is included in an infrastructure basic service set (BSS).

2. The method of claim 1, wherein the beacon interval of the plurality of APs is adjusted to a lower value than an original beacon interval.

3. The method of claim 1, wherein the beacon interval of the plurality of APs is adjusted to a higher value than an original beacon interval.

4. The method of claim 3, further comprising:
transmitting a request which commands an AP, among the plurality of APs, to transmit an unsolicited probe response frame; and
receiving a response, which includes a time point at which the unsolicited probe response frame is transmitted, to the request from the AP.

5. The method of claim 4, further comprising:
transmitting the time point to at least one devices within coverage of the AP.

6. The method of claim 4, wherein the request and the response is transmitted through a cellular network or an Internet protocol (IP) network.

7. The method of claim 1, wherein the primary RAT system is a cellular system, and
wherein the node is one of a eNodeB (eNB), a mobility management entity (MME), or a new entity of the cellular system.

8. The method of claim 1, wherein the secondary RAT system is a Wi-Fi system.

9. A method for transmitting, by an access point (AP) of a secondary radio access technology (RAT) system, a probe response frame in a wireless communication system, the method comprising:
receiving an adjusted beacon interval and an adjusted start point of the beacon interval so that beacon transmissions of a plurality of APs, included in an infrastructure basic service set (BSS), do not overlap each other from a node of a primary RAT system;
receiving a request which commands the AP to transmit an unsolicited probe response frame from the node of the primary RAT system;
transmitting a response, which includes a time point at which the unsolicited probe response frame is transmitted, to the request to the node of the primary RAT system; and
transmitting the unsolicited probe response frame.

10. The method of claim 9, wherein the adjusted beacon interval has a higher value than an original beacon interval.

11. The method of claim 9, wherein the unsolicited probe response frame is transmitted in an event-triggered manner.

12. A method for controlling, by a node of a primary radio access technology (RAT) system, an operation of a device in a wireless communication system, the method comprising:
transmitting a request message to a device of a secondary RAT system, wherein the request message includes an action which the device is to perform, and a frequency band in which the device operates.

13. The method of claim 12, wherein the request message is transmitted when client cooperation or direct communication between devices is required.

14. The method of claim 12, wherein the request message is transmitted the node of the primary RAT system measures interference of each frequency band.

15. The method of claim 12, wherein the action includes at least one of Wi-Fi radio frequency (RF) ON, Wi-Fi RF OFF, beacon transmission and beacon suspension.
